(19) United States
(12) Patent Application Publication
(10) Pub. No.: US 2025/0078365 A1
(43) Pub. Date: Mar. 6, 2025

(54) SIMULATING COMPONTENTS IN A LOAD CONTROL ENVIRONMENT

(71) Applicant: Lutron Technology Company LLC, Coopersburg, PA (US)

(72) Inventors: Craig Alan Erickson, Port Townsend, WA (US); Jonathan David Garn, Kula, HI (US); Jonathan Lawrence Mann, Seattle, WA (US)

(73) Assignee: Lutron Technology Company LLC, Coopersburg, PA (US)

(21) Appl. No.: 18/825,835

(22) Filed: Sep. 5, 2024

Related U.S. Application Data
(60) Provisional application No. 63/536,924, filed on Sep. 6, 2023.

(51) Int. Cl. G06T 11/60; G06F 3/04842

(52) U.S. Cl. CPC G06T 11/60; G06F 3/04842

(57) ABSTRACT

Characteristics of a window treatment fabric, a control device, and/or a lighting control system may be simulated for being installed in a space. A graphical representation of the window treatment fabric may be overlaid on an image being displayed on a display of a user device. A graphical representation of the control device may be overlaid on the image being displayed on the user device. A change in color temperature settings over a time of day may be simulated for lighting devices installed in a lighting control system in a space. A color graph may be overlaid on the image displayed on the user device that is configured with different color temperature values at a corresponding time of day and images may be displayed to reflect the corresponding color temperature values.

### CROSS-REFERENCE TO RELATED APPLICATIONS

This application claims the benefit of U.S. Provisional Patent application No. 63/536,924, filed Sep. 6, 2023, the entire disclosure of which is hereby incorporated by reference herein.

### BACKGROUND

A user environment, such as a residence, an office building, or a hotel for example, may be configured to include various types of load control systems. For example, a lighting control system may be used to control the lighting loads in the user environment. A motorized window treatment control system may be used to control the natural light provided to the user environment. A heating, ventilating, and air conditioning (HVAC) system may be used to control the temperature in the user environment.

### SUMMARY

Embodiments are described herein for simulating at least one characteristic of a window treatment fabric installed in a space. The at least one characteristic may comprise a color of the window treatment fabric and/or an openness factor of the window treatment fabric. As described herein, an image may be displayed on a display of a user device. A graphical representation of the window treatment fabric may be overlaid on the image being displayed on the display of the user device. The graphical representation of the window treatment fabric may have an identified openness factor while being displayed over the image. The graphical representation of the window treatment fabric may allow for a portion of the image to be displayed through the window treatment fabric to simulate the openness factor of the window treatment fabric. The openness factor may be one of a plurality of openness factors. The openness factor may be identified in response to a user selection of the openness factor from the plurality of openness factors. The openness factor may be defined with a percentage or ratio of openness.

The image over which the graphical representation of the window treatment fabric is displayed may be generated via a camera on the user device or may be a predefined image retrieved from memory. The image may be one of a plurality of images recorded live by the camera on the user device. The image may be taken in the space in which the user device is currently located.

Embodiments are described herein for simulating at least one characteristic of a control device installed in a space. For example, the at least one characteristic of the control device may comprise a color of a faceplate, a size of a faceplate, or a button configuration of the control device. An image may be displayed on a display of a user device. A graphical representation of the control device may be overlaid on the image being displayed on the display of the user device. The graphical representation of the control device may have the identified at least one characteristic. The graphical representation of the control device may allow for the control device having the at least one characteristic to be displayed to simulate the at least one characteristic being installed in the space.

The image over which the graphical representation of the control device is displayed may be generated via a camera on the user device or may be a predefined image retrieved from memory. The image may be one of a plurality of images recorded live by the camera on the user device. The image may be taken in the space in which the user device is currently located.

Embodiments are described herein for simulating a change in color temperature settings over a time of day for lighting devices installed in a lighting control system in a space. For example, at least one image may be displayed on a display of the user device. A color graph may be overlaid on the image displayed on the user device. The color graph may identify different color temperature values on a y-axis and different times of day on an x-axis. The color graph may be configured with different color temperature values for controlling lighting loads at a corresponding time of day. In response to identifying a time of day and a corresponding color temperature value on the graph, the at least one image being displayed on the user device may be updated to reflect the corresponding color temperature value at which the lighting devices would be controlled in the lighting system. The images that are displayed may comprise a plurality of predefined images taken at respective times of day to capture the corresponding color temperature values at which the lighting devices would be controlled in each image. The images may be updated by modifying one or more images of the space to achieve a corresponding color temperature value. The graph that is displayed may be configured with warmer color temperature values at a bottom portion of the y-axis and at a beginning portion and an end portion of the x-axis, as well as cooler color temperature values at a top portion of the y-axis and at a middle portion of the x-axis, to represent a rise and fall of color temperature values over time of day.

### BRIEF DESCRIPTION OF THE DRAWINGS

FIGS. 1A and 1C illustrate a simplified block diagram of a load control system.

FIG. 1B is a simplified block diagram that illustrates various characteristics of a window treatment.

FIGS. 2A-2R illustrate an example of one or more graphical user interfaces for simulating one or more features of a motorized window treatment and/or a covering material of the motorized window treatment.

FIGS. 3A-3P illustrate an example of one or more graphical user interfaces for simulating one or more features of a dimmer switch or a remote control device.

FIGS. 4A-4G illustrate an example of one or more graphical user interfaces for simulating one or more features of a lighting control system configured to control various color settings.

FIG. 5 is a flow diagram of an example procedure for simulating one or more features of a motorized window treatment and/or a covering material of the motorized window treatment.

FIG. 6 is a flow diagram of an example procedure for simulating one or more features of a keypad device.

FIG. 7 is a flow diagram of an example procedure for simulating one or more features of a lighting control system configured to control various color settings over time to emulate a sunrise and/or sunset.

FIG. 8 is a block diagram depicting an example computing device.

FIG. 9 is a block diagram depicting an example load control device.

### DETAILED DESCRIPTION

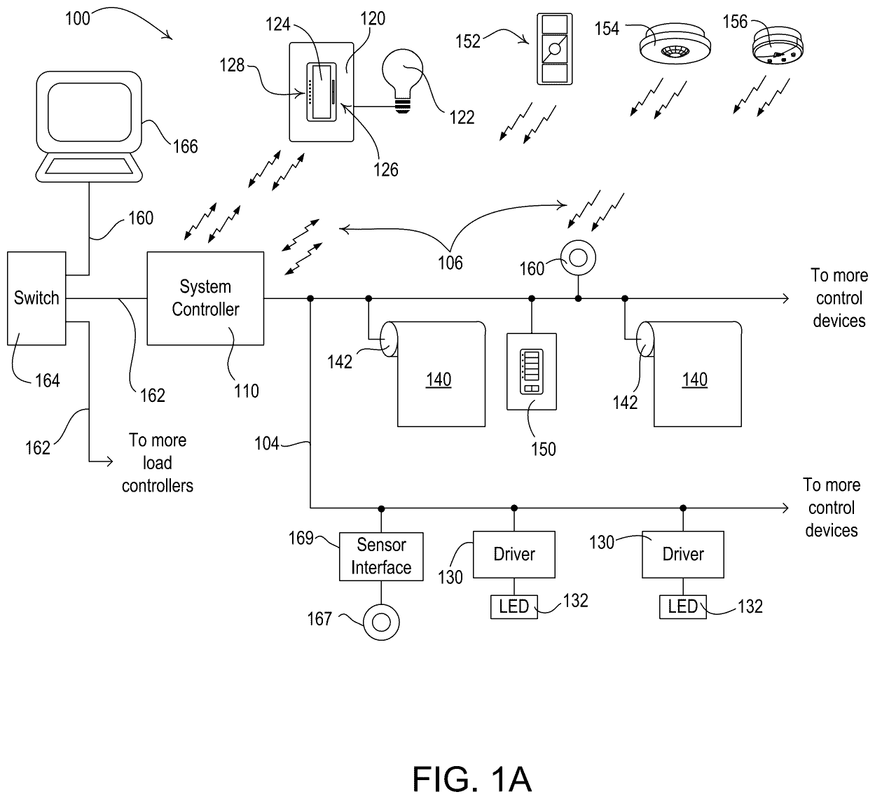

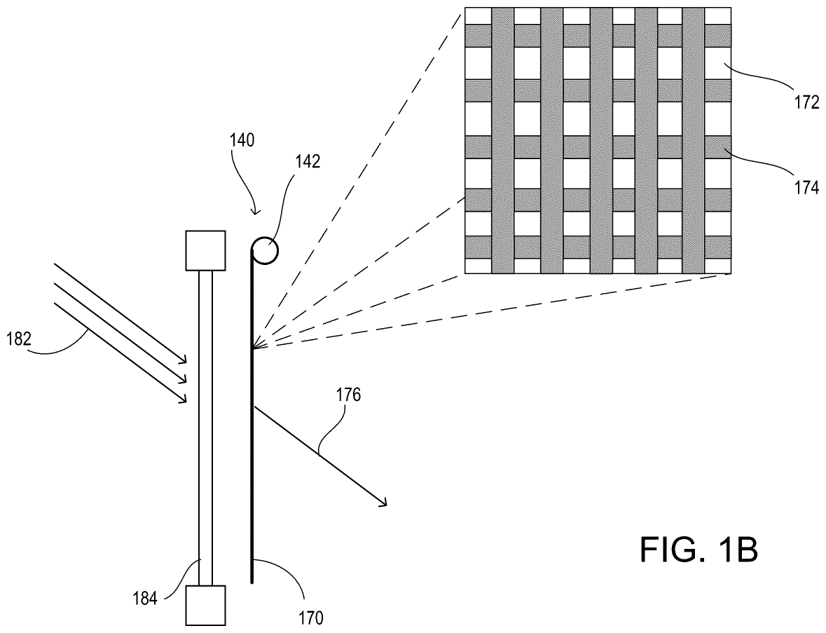

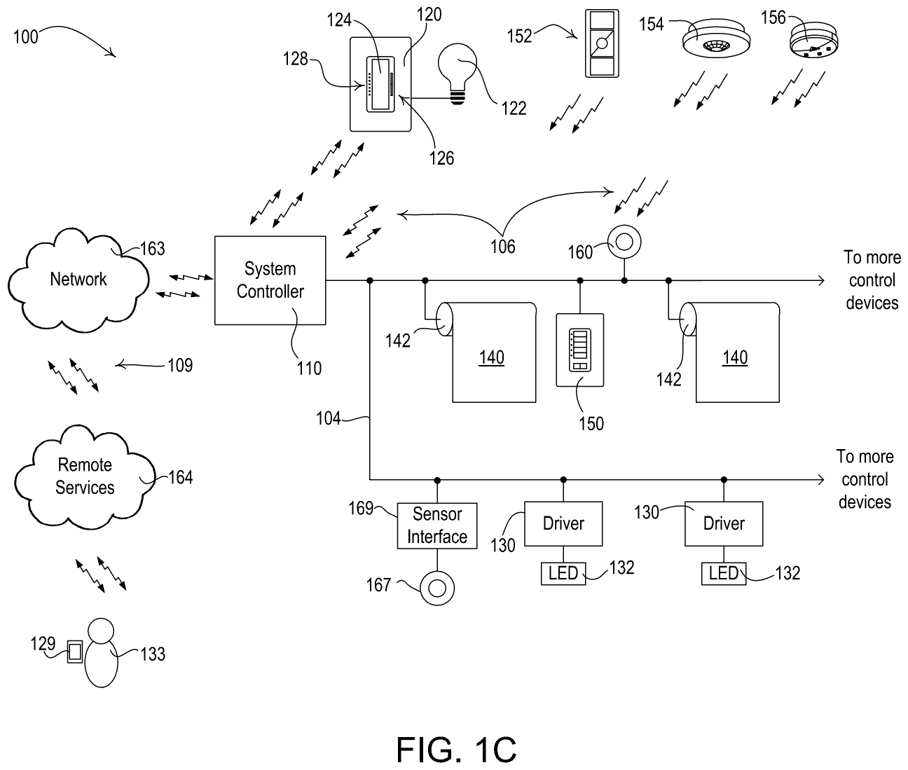

FIG. 1A is a simple diagram of an example load control system for controlling the amount of power delivered from an alternating-current (AC) power source (not shown), for example, to one or more electrical loads. The load control system 100 may comprise a number of control devices for controlling electrical loads. The control devices may comprise input devices and/or load control devices for controlling electrical loads. The input devices may be operable to transmit messages in response to user inputs, sensor inputs, or other input information and transmit messages for enabling load control. The control devices may include load control devices that may be operable to receive messages and/or control respective electrical loads in response to the received messages from input devices or other devices in the load control system 100. Though described as being transmitted in a message or a command, one or more messages or commands may be used to convey the information of the message or the command.

The control devices in the load control system 100 may comprise one or more load control devices, such as light-emitting diode (LED) drivers 130 for driving respective LED light sources 132 (e.g., LED light engines). The LED drivers 130 may be located, for example, in lighting fixtures of the respective LED light sources 132. The LED drivers 130 may be configured to receive messages from one or more devices via the communication link 104 and to control the respective LED light sources 132 in response to the received messages. The LED drivers 130 may be coupled to a separate communication link, such as an ECOSYSTEM or digital addressable lighting interface (DALI) communication link, and the load control system 100 may include a digital lighting controller coupled between the communication link 104 and the separate communication link. In addition or alternatively, the LED drivers 130 may include internal RF communication circuits or be coupled to external RF communication circuits (e.g., mounted external to the lighting fixtures, such as to a ceiling) for transmitting and/or receiving RF signals 106 from one or more devices and to control the respective LED light sources 132 in response to the received messages. The load control system 100 may further comprise other types of load control devices for controlling lighting loads.

The load control system 100 may further comprise a plurality of daylight control devices, e.g., motorized window treatments, such as motorized roller shades 140, to control the amount of daylight entering a building in which the load control system 100 may be installed. A motorized roller shade 140 may comprise a covering material (e.g., a shade fabric). The covering material may be wound around a roller tube for raising and/or lowering the shade fabric. The motorized roller shades 140 may comprise electronic drive units 142. The electronic drive units 142 may be located inside a roller tube of the motorized roller shade. The electronic drive units 142 may be coupled to the communication link 104 for transmitting and/or receiving messages. The electronic drive units 142 may include a control circuit. The control circuit may be configured to adjust the position of a window treatment fabric, for example, in response to messages received from a system controller 110 via the communication link 104. Each of the electronic drive units 142 may include memory for storing association information for associations with other devices and/or instructions for controlling the motorized roller shade 140. In addition or alternatively, the electronic drive units 142 may comprise an internal RF communication circuit. The electronic drive units 142 may also, or alternatively, be coupled to an external RF communication circuit (e.g., located outside of the roller tube) for transmitting and/or receiving the RF signals 106 to/from one or more devices and to control the respective motorized roller shades 140 in response to the received messages. The load control system 100 may comprise other types of daylight control devices or motorized window treatments, such as, for example, a cellular shade, a drapery, a Roman shade, a Venetian blind, a Persian blind, a pleated blind, a tensioned roller shade systems, an electrochromic or smart window, and/or other suitable daylight control device.

The load control system 100 may comprise a load control device, such as a dimmer switch 120, for controlling a lighting load 122. The dimmer switch 120 may be adapted to be wall-mounted in a standard electrical wallbox. The dimmer switch 120 may comprise a tabletop or plug-in load control device. The dimmer switch 120 may comprise one or more toggle actuators 124 (e.g., buttons) and/or an intensity adjustment actuator 126 (e.g., a rocker switch or buttons). Successive actuations of the toggle actuator 124 may toggle, e.g., turn off and on, the lighting load 122. Actuations of an upper portion or a lower portion of the intensity adjustment actuator 126 may respectively increase or decrease the amount of power delivered to the lighting load 122 and increase or decrease the intensity of the lighting load from a minimum intensity (e.g., approximately 1%) to a maximum intensity (e.g., approximately 100%). The dimmer switch 120 may further comprise a plurality of visual indicators 128, e.g., light-emitting diodes (LEDs), which may be arranged in a linear array and/or may be illuminated to provide feedback of the intensity of the lighting load 122. Examples of wall-mounted dimmer switches are described in greater detail in U.S. Pat. No. 5,248,919, issued Sep. 28, 1993, entitled LIGHTING CONTROL DEVICE, and U.S. Pat. No. 9,679,696, issued Jun. 13, 2017, entitled WIRELESS LOAD CONTROL DEVICE, the entire disclosures of which are hereby incorporated by reference.

The load control system 100 may comprise one or more other types of load control devices, such as, for example, a screw-in luminaire including a dimmer circuit and an incandescent or halogen lamp; a screw-in luminaire including a ballast and a compact fluorescent lamp; a screw-in luminaire including an LED driver and an LED light source; an electronic switch, a controllable circuit breaker, or other switching device for turning an appliance on and off; a plug-in load control device, a controllable electrical receptacle, or a controllable power strip for controlling one or more plug-in loads; a motor control unit for controlling a motor load, such as a ceiling fan or an exhaust fan; a drive unit for controlling a motorized window treatment or a projection screen; motorized interior or exterior shutters; a thermostat for a heating and/or cooling system; a temperature control device for controlling a setpoint temperature of a heating, ventilation, and air conditioning (HVAC) system; an air conditioner; a compressor; an electric baseboard heater controller; a controllable damper; a variable air volume controller; a fresh air intake controller; a ventilation controller; hydraulic valves for use in radiators and radiant heating systems; a humidity control unit; a humidifier; a dehumidifier; a water heater; a boiler controller; a pool pump; a refrigerator; a freezer; a television or computer monitor; a video camera; an audio system or amplifier; an elevator; a power supply; a generator; an electric charger, such as an electric vehicle charger; and/or an alternative energy controller.

The control devices of the load control system 100 may comprise one or more input devices, e.g., such as a wired keypad device 150 and/or a wired sensor 167, for transmitting messages on a wired communication link 104 for controlling one or more electrical loads. The wired keypad device 150 may be configured to transmit messages via the wired communication link 104 in response to an actuation of one or more buttons of the wired keypad device 150. The messages may include an indication of the button pressed on the wired keypad device 150. The wired keypad device 150 may be adapted to be wall mounted in a standard electrical wallbox.

The wired sensor 167 may be configured to perform measurements and transmit messages on the wired communication link 104 in response to the measurements. For example, the wired sensor 167 may be a wired daylight sensor configured to measure (e.g., periodically measure) a signal (e.g., a photosensor or photodiode current) that may be used to determine a value indicative of a light intensity in the space in which the wired sensor 167 is installed (e.g., sensor data). The wired sensor 167 may be an occupancy and/or vacancy sensor configured to transmit messages on the wired communication link 104 in response to sensing an occupancy and/or vacancy condition for controlling an electrical load in the load control system 100. The wired sensor 167 may transmit messages that include occupancy conditions and/or a vacancy conditions identified by the wired sensor 167. The wired sensor 167 may be a color temperature sensor configured to measure (e.g., periodically measure) a signal that may be used to determine a value indicative of a color temperature in the space in which the wired color temperature sensor 167 is installed (e.g., sensor data). The wired sensor 167 may be a daylight sensor configured to transmit messages on the wired communication link 104 in response to sensing a daylight value (e.g., such as foot-candles or another daylight value indicating an amount of natural light intensity) for controlling an electrical load in the load control system 100.

The wired sensor 167 may be configured to be coupled with a sensor interface 169. The wired sensor 167 may transmit messages (e.g., which may include a respectively measured signal) to the sensor interface 169 periodically in response to periodic measurements. The sensor interface 169 may be configured to transmit a message via the wired communication link 104 in response to a message received from the wired sensor 167. For example, the sensor interface 169 may be configured to convert the signal measured by the wired sensor 167 into an appropriate value that indicates the measurements taken in the space (e.g., a daylight value, such as foot-candles or another daylight value, a color temperature value, an intensity level, etc.) and may further transmit the value via the wired communication link 104. For example, the value may be used for controlling the intensities of one or more of the electrical loads in the load control system and/or to raise/lower motorized roller shades.

One or more input devices in the load control system 100 may send messages via wireless communications for enabling load control. The load control system 100 may comprise one or more input devices, e.g., a remote control device 152 which may be battery powered, an occupancy sensor 154, and/or a daylight sensor 156. The remote control device 152, the occupancy and/or vacancy sensor 154, and/or the daylight sensor 156 may be wireless control devices (e.g., RF transmitters) configured to transmit messages to other devices via the RF signals 106. For example, the remote control device 152 may be configured to transmit messages to other devices via the RF signals 106 in response to an actuation of one or more actuators (e.g., buttons) of the remote control device 152. As the remote control device 152 and the dimmer switch 120 may include one or more actuators or buttons, the remote control device 152 and the dimmer switch 120 may be keypad devices comprising one or more buttons or keys configured to control an electrical load. The occupancy and/or vacancy sensor 154 may be configured to transmit messages to other devices via the RF signals 106 in response to detection of occupancy and/or vacancy conditions in the space in which the load control system 100 may be installed. The daylight sensor 156 may be configured to transmit messages to other devices via the RF signals 106 in response to detection of different amounts of natural light intensity.

The load control system 100 may comprise a system controller 110 operable to transmit and/or receive messages via a wired and/or a wireless communication link. For example, the system controller 110 may be coupled to one or more wired devices via a wired communication link 104. The system controller 110 may be configured to transmit and/or receive wireless signals, e.g., radio-frequency (RF) signals 106, to communicate with one or more wireless devices. The system controller 110 may operate as an intermediary device between the input devices and the load control devices. The system controller 110 may be configured to receive messages from the input devices and transmit messages to the load control devices in response to the messages received from the input devices. The input devices and the load control devices may also, or alternatively, communicate directly.

The load control system 100 may comprise a wireless adapter device 160 that may be coupled to the communication link 104. The wireless adapter device 160 may be configured to receive the RF signals 106. The wireless adapter device 160 may be configured to transmit a message to the system controller 110 via the communication link 104 in response to a message received from one of the wireless control devices via the RF signals 106. For example, the wireless adapter device 160 may re-transmit the messages received from the wireless control devices on the communication link 104.

The system controller 110 may be configured to transmit one or more messages to the load control devices (e.g., the dimmer switch 120, the LED drivers 130, and/or the motorized roller shades 140) in response to the received messages from one or more input devices, e.g., from the wired keypad device 150, the wired sensor 167, the remote control device 152, the occupancy and/or vacancy sensor 154, and/or the daylight sensor 156. While the system controller 110 may receive messages from the input devices and/or transmit messages to the load control devices for controlling an electrical load, the input devices may communicate directly with the load control devices for controlling the electrical load.

The occupancy and/or vacancy sensor 154 may be configured to detect occupancy and/or vacancy conditions in the space in which the load control system 100 may be installed. The occupancy and/or vacancy sensor 154 may transmit messages to the system controller 110 via the RF signals 106 in response to detecting the occupancy and/or vacancy conditions. The system controller 110 may be configured to turn one or more of the lighting load 122 and/or the LED light sources 132 on and off in response to receiving an occupied command and a vacant command, respectively. The occupancy sensor 154 may operate as a vacancy sensor, such that the lighting loads are turned off in response to detecting a vacancy condition (e.g., not turned on in response to detecting an occupancy condition). Examples of RF load control systems having occupancy and vacancy sensors are described in greater detail in U.S. Pat. No. 8,009,042, issued Aug. 30, 2011, entitled RADIO-FREQUENCY LIGHTING CONTROL SYSTEM WITH OCCUPANCY SENSING; U.S. Pat. No. 8,199,010, issued Jun. 12, 2012, entitled METHOD AND APPARATUS FOR CONFIGURING A WIRELESS SENSOR; and U.S. Pat. No. 8,228,184, issued Jul. 24, 2012, entitled BATTERY-POWERED OCCUPANCY SENSOR, the entire disclosures of which are hereby incorporated by reference.

The daylight sensor 156 may be configured to measure a total light intensity in the space in which the load control system is installed. The daylight sensor 156 may transmit messages including the measured light intensity to the system controller 110 via the RF signals 106. The messages may be used to control an electrical load (e.g., the intensity and/or color of lighting load 122, the motorized window shades 140 for controlling the level of the covering material, the intensity of the LED light sources 132) via one or more control load control devices (e.g., the dimmer switch 120, the electronic drive unit 142, the LED driver 130). Examples of RF load control systems having daylight sensors are described in greater detail in U.S. Pat. No. 8,410,706, issued Apr. 2, 2013, entitled METHOD OF CALIBRATING A DAYLIGHT SENSOR; and U.S. Pat. No. 8,451,116, issued May 28, 2013, entitled WIRELESS BATTERY-POWERED DAYLIGHT SENSOR, the entire disclosures of which are hereby incorporated by reference.

The load control system 100 may comprise other types of input device, such as: temperature sensors; humidity sensors; radiometers; pressure sensors; smoke detectors; carbon monoxide detectors; air quality sensors; motion sensors; security sensors; proximity sensors; fixture sensors; partition sensors; keypads; kinetic- or solar-powered remote controls; key fobs; cell phones; smart phones; tablets; personal digital assistants; personal computers; laptops; timeclocks; audio-visual controls; safety devices; power monitoring devices (such as power meters, energy meters, utility submeters, utility rate meters); central control transmitters; residential, commercial, or industrial controllers; or any combination of these input devices. These input devices may transmit messages to the system controller 110 via the RF signals 106. The messages may be used to control an electrical load (e.g., the intensity and/or color of lighting load 122, the motorized window shades 140 for controlling the level of the covering material, and/or the intensity of the LED light sources 132) via one or more control load control devices (e.g., the dimmer switch 120, the electronic drive unit 142, and/or the LED driver 130).

The system controller 110 may be configured to control the load control devices (e.g., the dimmer switch 120, the LED drivers 130, and/or the motorized roller shades 140) according to a timeclock schedule. The timeclock schedule may be stored in a memory in the system controller 110. The timeclock schedule may include a number of timeclock events. The timeclock events may have an event time and a corresponding command or preset. The system controller 110 may be configured to keep track of the present time and/or day. The system controller 110 may transmit the appropriate command or preset at the respective event time of each timeclock event. An example of a load control system for controlling one or more motorized window treatments according to a timeclock schedule is described in greater detail in U.S. Pat. No. 8,288,981, issued Oct. 16, 2012, entitled METHOD OF AUTOMATICALLY CONTROLLING A MOTORIZED WINDOW TREATMENT WHILE MINIMIZING OCCUPANT DISTRACTIONS, the entire disclosure of which is hereby incorporated by reference.

The load control system 100 may be part of an automated lighting control system. The system controller 110 may control the lighting control devices (e.g., the dimmer switch 120 and/or the LED drivers 130) to each adjust various settings of the corresponding lighting load (e.g., lighting load 122 and/or LEDs 132) to adjust the light emitted from the lighting load. For example, the lighting control devices may be controlled to adjust the lighting intensity level (i.e., brightness), the color (e.g., correlated color temperature (CCT) value or full color value), a value of a vibrancy parameter affecting color saturation, and/or other lighting control settings. Further, the lighting control devices (e.g., the dimmer switch 120 and/or the LED drivers 130) may each be controlled to adjust the settings of lighting load(s) (e.g., lighting load 122 and/or LEDs 132) over time (e.g., which may be referred to as natural show or natural lighting). For example, the lighting control devices may each adjust the settings of the respective lighting loads over time to emulate a sunrise and/or sunset, which may be based on the local time of sunrise and/or sunset for the load control system 100.

Each lighting control device and respective lighting load may be configured to produce white or near-white light of varying brightness/intensities within a range of CCTs ranging from “warm white” (e.g., roughly 2600 Kelvin (K)-3700 K), to “neutral white” (e.g., 3700 K-5000 K) to “cool white” (e.g., 5000 K-8300 K) for example. For example, the lighting control devices (e.g., the dimmer switch 120 and/or the LED drivers 130) and respective lighting loads (e.g., lighting load 122 and/or LEDs 132) may be configured to produce light of varying chromaticity coordinates that lie along the black body locus or curve. As a further example, such a lighting control device and its respective lighting load may be further configured to produce any of a plurality of colors of varying brightness/intensities within the color gamut formed by the various LEDs that make up the lighting load.

Each lighting control device and its respective lighting load may be controlled to increase and/or decrease a color saturation of objects in the space. For example, the lighting control devices (e.g., the dimmer switch 120 and/or the LED drivers 130) may control or be responsive to a vibrancy parameter that is configured to control the color saturation of the objects in the space. The vibrancy parameter may allow the lighting control devices to tune the individual colors that make light at a given color (e.g., full color or a CCT). The vibrancy parameter may cause the lighting control device to control the power provided to the LEDs of the corresponding lighting load to adjust the intensities of the various wavelengths of the light emitted by the lighting load, which may affect the color of the light (e.g., the reflected light) on objects within the space. Increases and decreases in the value of the vibrancy parameter may increase/decrease the color saturation of objects in the area without changing the color of the light when a user looks at the light (e.g., the color of the emitted light). In an example, the vibrancy parameter may be a relative value (e.g., between zero and one-hundred percent) for increasing/decreasing the color saturation of the objects in the space. Changing the relative value of the vibrancy parameter may cause the lighting control devices (e.g., the dimmer switch 120 and/or the LED drivers 130) to decrease or increase the intensity of one or more white LEDs (e.g., white or substantially white LEDs) that make up the respective lighting loads (e.g., lighting load 122 and/or LEDs 132). For example, increasing the value of the vibrancy parameter may thereby decrease the intensity of the one or more white LEDs that make up the respective lighting loads, and thereby increase the color saturation of the objects in the space. Decreasing the value of the vibrancy parameter may thereby increase the intensity of the one or more white LEDs that make up the respective lighting loads, and thereby decrease the color saturation of the objects in the space. Changing the value of the vibrancy parameter in this manner may also include changing the intensities of other LEDs (e.g., red, green, and/or blue LEDs) of the lighting loads to maintain the same color output of the lighting loads (e.g., to maintain the same (or approximately the same within one or more MacAdam ellipses) chromaticity coordinates of the mixed color output of the lighting loads). Adjusting the vibrancy value may, however, adjust the light reflected off of objects in the space. In addition, adjusting the vibrancy value may adjust spectral power distribution (SPD) of the light. For example, as the vibrancy value increases, an SPD curve of the emitted light (e.g., relative intensity versus wavelength) may become sharper and/or may result in individual colors on the objects to appear more vibrant when the light reflects off of them. One example of a lighting control device and respective lighting load is described as illumination device of U.S. Pat. No. 10,237,945, issued Mar. 19, 2019, entitled ILLUMINATION DEVICE, SYSTEM AND METHOD FOR MANUALLY ADJUSTING AUTOMATED PERIODIC CHANGES IN EMULATION OUTPUT, the contents of which are hereby incorporated by reference in their entirety. One will recognize that other examples lighting control device and respective lighting loads are possible.

A light output of the lighting loads may be measured by a color rendering index (CRI) value. The CRI value may be a measurement of the lighting load's ability to reveal the actual color of objects as compared to an ideal light source (e.g., natural light). A higher CRI value may be a desirable characteristic of a user. For example, a lighting load with a higher CRI value may provide light such that the objects within a space reflect light at a natural color. With respect to the lighting loads described herein, each of the respective LEDs that are comprised within a RGBW lighting load, for example, may be defined by a certain CRI value. In addition, an RGBW lighting load, for example, itself may be defined by a CRI value (e.g., a CRI value that indicates a summary or average CRI of each of the respective LEDs comprised within the lighting load). CRI values may be in the range of 0 to 100, inclusively. For example, the lowest possible CRI value may be 0 and the highest possible CRI value may be 100. In certain instances, the CRI value of a lighting load may be increased to a value greater than or equal to a threshold CRI value. For example, the threshold CRI value may be 90. One will appreciate, however, that the threshold CRI value may be other values. Rather, the CRI threshold value may be a value which may be considered a desirable threshold that a system may attempt to achieve given the certain characteristics of the load control system 100 and/or lighting control devices (e.g., quality of the LEDs used in a lighting load). Adjusting a CRI value may be a feature that is enabled through a vibrancy state/mode whereas when vibrancy is adjusted, the CRI value is also adjusted.

The load control system 100 may be part of an automated window treatment control system. The system controller 110 may control the shades according to automated window treatment control information. For example, the automated window treatment control information may include the angle of the sun, sensor information, an amount of cloud cover, and/or weather data, such as historical weather data and/or real-time weather data. For example, throughout the course of a calendar day, the system controller 110 of the automated window treatment control system may adjust the position of the window treatment fabric multiple times, based on the calculated position of the sun and/or sensor information. The automated window treatment control system may determine the position of the window treatments in order to affect a performance metric. The automated window treatment system may command the system controller 110 to adjust the window treatments to the determined position in order to affect a performance metric (e.g., such as glare and/or light intensity entering a space through a window, view outside of the window, privacy, etc.). The automated window treatment control system may operate according to a timeclock schedule. Based on the timeclock schedule, the system controller may change the position of the window treatments throughout a calendar day. The timeclock schedule may be set to prevent a daylight penetration distance (e.g., the distance into a space in which sunlight entering through a window reaches) from exceeding a maximum distance into an interior space (e.g., work space, transitional space, or social space). The maximum daylight penetration distance may be set to a user's workspace. The system controller 110 may adjust the position of the window treatments according to collected sensor information. The motorized window treatments may store the timeclock schedule in memory (e.g., in response to a message from the system controller 110 or another device) and operate according to the timeclock schedule stored locally thereon.

The system controller 110 may be operable to be coupled to a network, such as a wireless and/or wired local area network (LAN) via a network communication bus 162 (e.g., an Ethernet communication link), e.g., for access to the Internet. The system controller 110 may be connected to a network switch 164 (e.g., a router or Ethernet switch) via the network communication bus 162 for allowing the system controller 110 to communicate with other system controllers for controlling other electrical loads. The system controller 110 may be wirelessly connected to the network, e.g., using Wi-Fi technology. The system controller 110 may be configured to communicate via the network with one or more user devices, such as a smart phone, a personal computer 166, a laptop, a tablet device, a Wi-Fi or wireless-communication-capable television, and/or any other suitable wireless communication device. The user devices may be operable to transmit messages directly or indirectly to the system controller 110 in one or more Internet Protocol packets, for example, such as to control loads in the space (e.g., lighting levels, CCT values, full color values, window treatment levels, etc.) and/or to configure the load control system (e.g., timeclock values). Examples of load control systems operable to communicate with user devices on a network are described in greater detail in U.S. Pat. No. 10,271,407, issued Apr. 23, 2019, entitled LOAD CONTROL DEVICE HAVING INTERNET CONNECTIVITY, the entire disclosure of which is hereby incorporated by reference.

The operation of the load control system 100 may be programmed and/or configured using the personal computer 166 or another user device. The personal computer 166 may execute a graphical user interface (GUI) configuration software for allowing a user to program how the load control system 100 may operate. The configuration software may generate load control information (e.g., a load control database) that defines the operation and/or performance of the load control system 100. For example, the load control information may include information regarding the different load control devices of the load control system (e.g., the dimmer switch 120, the LED drivers 130, and/or the motorized roller shades 140). The load control information may include information regarding associations between the load control devices and the input devices (e.g., the wired keypad device 150, the wired sensor 167, the battery-powered remote control device 152, the occupancy sensor 154, and/or the daylight sensor 156), and/or how the load control devices may respond to input received from the input devices. Devices may be configured such that the devices are associated with one another in memory for recognizing messages communicated between associated devices and performing load control and/or identifying communications based on such messages. For example, the load control devices and the input devices may be configured such that the devices are associated with one another for recognizing messages communicated between associated devices and performing load control based on such messages. Examples of configuration procedures for load control systems are described in greater detail in U.S. Pat. No. 7,391,297, issued Jun. 24, 2008, entitled HANDHELD PROGRAMMER FOR LIGHTING CONTROL SYSTEM; U.S. Patent Application Publication No. 2008/0092075, published Apr. 17, 2008, entitled METHOD OF BUILDING A DATABASE OF A LIGHTING CONTROL SYSTEM; and U.S. Pat. No. 10,027,127, issued Jul. 17, 2018, entitled COMMISSIONING LOAD CONTROL SYSTEMS, the entire disclosures of which are each hereby incorporated by reference.

The system controller 110 may be configured to automatically control the motorized window treatments (e.g., the motorized roller shades 140). The motorized window treatments may be controlled to save energy and/or improve the comfort of the occupants of the building in which the load control system 100 may be installed. For example, the system controller 110 may be configured to automatically control the motorized roller shades 140 in response to a timeclock schedule and/or the daylight sensor 156. The motorized roller shades 140 may be manually controlled by the wired keypad device 150 and/or the remote control device 152.

The covering material or fabric of the window treatments may be characterized by an openness factor. FIG. 1B is a diagram illustrating characteristics of a covering material, such as a shade fabric 170, installed on a motorized window treatment, such as motorized roller shades 140. As illustrated in FIG. 1B, the shade fabric 170 may include an area of open space 172 and an area of fabric material 174. The openness factor may indicate the area of open space 172 in the shade fabric 170. For example, an openness factor of 10% may indicate that the total area of open space and area of shade fabric 170 comprises 10% open space. The openness factor may be a nominal factor. A nominal factor may be an approximate factor, such as when a single fabric measurement for openness factor is not available for the fabric. The openness factor may be a measured openness factor. A measured openness factor may be when only a single openness factor measurement is available for the fabric. The openness factor may be a mean openness factor. A mean openness factor may be when the average measured data is available for the fabric.

FIG. 1B illustrates other characteristics of the covering material or shade fabric 170. As shown in FIG. 1B, natural light 182 may be received at a window 184 and may meet the shade fabric 170 (e.g., covering material). A characteristic of the covering material or shade fabric 170 may include a visible light transmittance that may indicate an amount of visible light transmission 176 that may be allowed through the shade fabric 170. The color of the shade fabric 170 itself and/or the openness factor of the shade fabric 170 may affect the visible light transmittance of the covering material. For example, a more open weave and/or a lighter color for the shade fabric 170 may allow more visible light transmittance of the covering material than a more closed weave and/or darker color for the shade fabric 170, which may result in more visible light in the space and/or a greater view of objects through the fabric. In an example, the visible light transmittance of the covering material may be defined as a percentage of the natural light 182 that meets the shade fabric 170 and/or passes through the shade fabric 170. A darker color of shade fabric 170 may allow for a user to have a greater view through the shade fabric 170 than a lighter color of shade fabric with the same openness factor.

The openness factor and/or the visible light transmittance of the covering material may affect the energy savings of the load control system and/or the comfort of the occupants. For example, a shade fabric 170 having a higher openness factor may allow more of the natural light 182 to pass through. This higher openness factor may provide more energy savings for the load control system 100 since the lighting loads may be dimmed or turned off. A high visible light transmittance of the covering material may lead to conditions of high daylight glare.

The effect of certain components being installed in the load control system 100 or the effect of the components in a space may be difficult to understand or appreciate prior to the installation of the actual components. For example, the effect of a motorized window treatment and/or the covering material or fabric stored thereon may be difficult to understand or appreciate without installation of the motorized window treatment and covering material or fabric in the space. Specific characteristics of the covering material may be particularly difficult to understand or appreciate. For example, the difference in view through a covering material or natural light allowed into a space through the covering material may be difficult to understand for fabrics or covering materials having different openness factors. The characteristics of the covering material may also be affected based on changes to the settings of other control devices in the load control system 100, which may also be difficult to understand or appreciate. For example, changes to lighting intensity settings and/or color settings, such as CCT settings, full color settings, and/or vibrancy settings affecting color saturation, may affect the characteristics of the covering material, which may also be difficult to understand or appreciate for a given space. Similarly, various settings of the lighting control devices and/or lighting load may be difficult to understand or appreciate prior to installation in the load control system. For example, the various color settings, such as CCT settings, full color settings, and/or vibrancy settings affecting color saturation, may be difficult to understand or appreciate for a given space, particularly when one or more of these settings are being controlled over time (e.g., via natural show or natural lighting settings) to emulate a sunrise and/or sunset for example. Embodiments are described herein to allow for simulation of components of the load control system 100 prior to installation in a space. As shown in FIG. 1C, a graphical user interface may be displayed on a user device 129 to simulate components of the load control system 100 to a user 133. The user device 129 may be a computing device executing software for enabling simulation of the components in the load control system 100. The user device 129 may be a personal computing device, such as a laptop, a smart phone, a tablet device, and/or a wearable device (such as wearable glasses or another wearable device). The user device 129 may be configured to transmit messages to the system controller 110, for example, in one or more messages transmitted via Internet Protocol packets and/or another wireless communication protocol (e.g., BLUETOOTH, etc.). The user device 129 may be configured to transmit messages over the network 163 to an external service, and then the messages may be received by the system controller 110. The user device 129 may transmit and receive RF signals 109. The RF signals 109 may be the same wireless frequency and/or transmitted using the same protocol as the RF signals 106. Alternatively, or additionally, the user device 129 may be configured to transmit RF signals 109 according to another signal type and/or protocol. Examples of load control systems operable to communicate with mobile and/or computing devices on a network are described in greater detail in U.S. Patent Application Publication No. 10,271,407, issued Apr. 23, 2019, entitled LOAD CONTROL DEVICE HAVING INTERNET CONNECTIVITY, the entire disclosure of which is hereby incorporated by reference.

The user device 129 may provide a graphical user interface via a display on the user device 129 for simulating the components of the load control system 100 to the user 133. The graphical user interface may be provided via a simulation application executing on the user device 129 and/or via another device, such as the system controller 110, a remote computing device executing remote services 164, and/or another computing device. The remote services 164 may be provided on one or more remote computing devices, such as one or more cloud servers or other remote servers with which the system controller 110 and/or the user device 129 may be configured to communicate via the network 163. For example, the remote server operating the remote services 164 may communicate with the system controller 110 and/or the user device 129 via the network 163 and RF signals 109. The remote services 164 may include or have access to one or more portions of the load control system 100 for enabling load control by the user 133 after installation of one or more components of the load control system 100. Additionally, or alternatively, one or more portions of the load control system 100 may be configured and/or controlled by messages transmitted to the system controller 110 and/or the remote services 164 for performing configuration and/or control of the load control system 100. The remote services 164 may be operated by a server or may be serverless. The remote services 164 may be accessed via a web-based application, such as a web browser or other application executing locally on the user device 129 for providing output via the remote services and/or input to the remote services 164.

After the installation of the devices in the load control system 100, the installed devices may be powered on and activated for enabling operation of the installed devices in the physical space. The operation of the load control system 100 may be programmed and configured using, for example, the user device 129 or other computing device (e.g., when the user device is a personal computing device). The user device 129 may provide the user with access to a control/configuration application (e.g., via a graphical user interface (GUI)) for allowing a user 133 to program how the load control system 100 will operate and/or be controlled. For example, the control/configuration application may be executed as a local application on the user device 129, or as a remote application or service (e.g., executing via the remote services 164 on the remote server, the system controller 110, and/or another remote computing device) that is accessed via a local application (e.g., a web browser or other local application enabling a web interface). The control/configuration application may generate and/or store the system configuration data for enabling control of the devices in the load control system 100. The system configuration data may comprise one or more load control databases that define the operation of the load control system 100. Examples of configuration procedures for load control systems are described in greater detail in U.S. Pat. No. 7,391,297, issued Jun. 24, 2008, entitled HANDHELD PROGRAMMER FOR A LIGHTING CONTROL SYSTEM; U.S. Patent Application Publication No. 2008/0092075, published Apr. 17, 2008, entitled METHOD OF BUILDING A DATABASE OF A LIGHTING CONTROL SYSTEM; and U.S. Pat. No. 10,027,127, issued Jul. 17, 2018, entitled COMMISSIONING LOAD CONTROL SYSTEMS, the entire disclosures of which are hereby incorporated by reference.

In addition to configuring the system, the control/configuration application may be implemented to control one or more components in the load control system 100, such as the load control devices of the load control system (e.g., the dimmer switch 120, the LED drivers 130, and/or the motorized roller shades 140). In a still further example, the control/configuration application may be implemented to simulate one or more components (e.g., a motorized roller shade, a keypad device, or other component) of the load control system 100 to the user 133 via a graphical user interface, while the user performs control of one or more other components in the load control system 100, such as the load control devices of the load control system (e.g., the dimmer switch 120, the LED drivers 130, and/or the motorized roller shades 140). The graphical user interface displayed by the control/configuration application may be updated in response to the control of the one or more components in the load control system 100 to illustrate the effect of additional components being installed in the load control system 100.

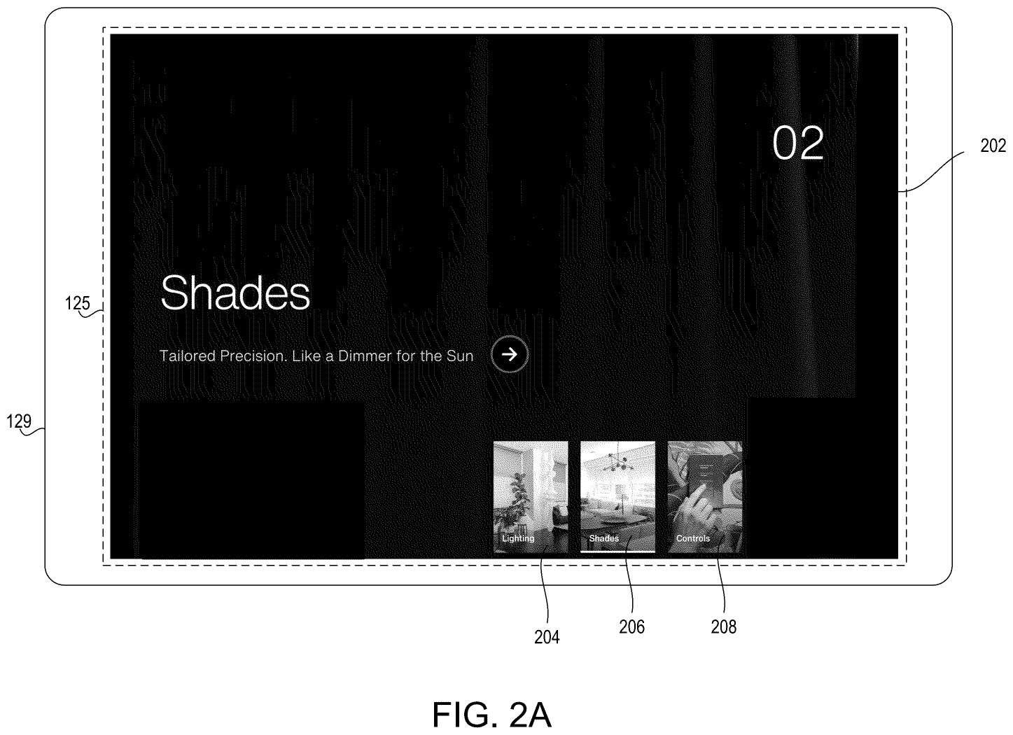

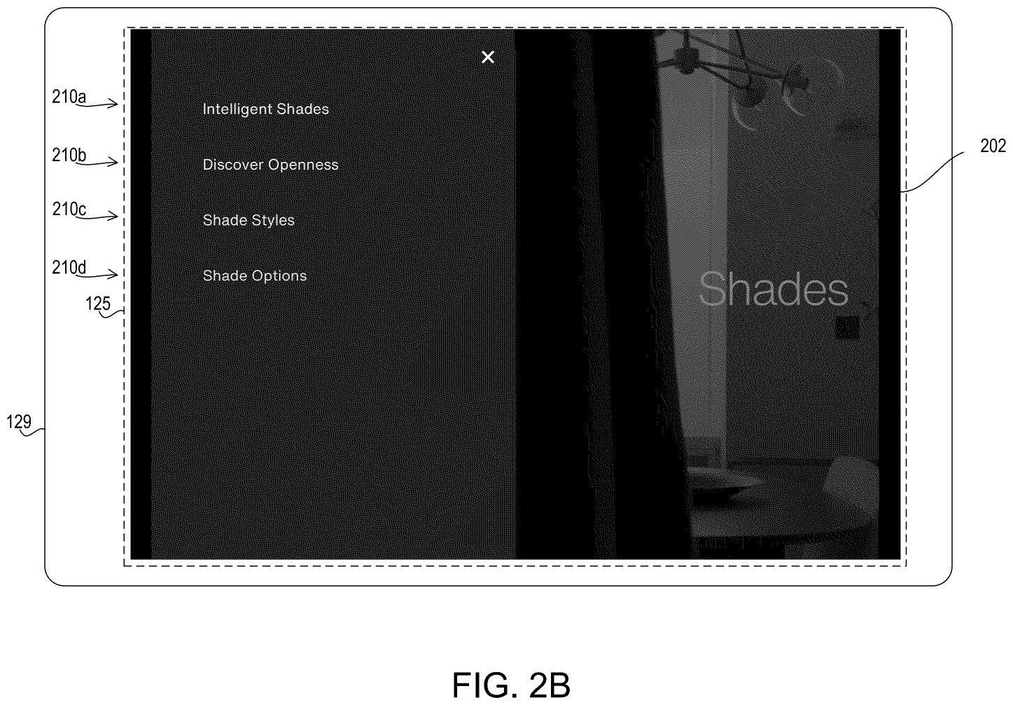

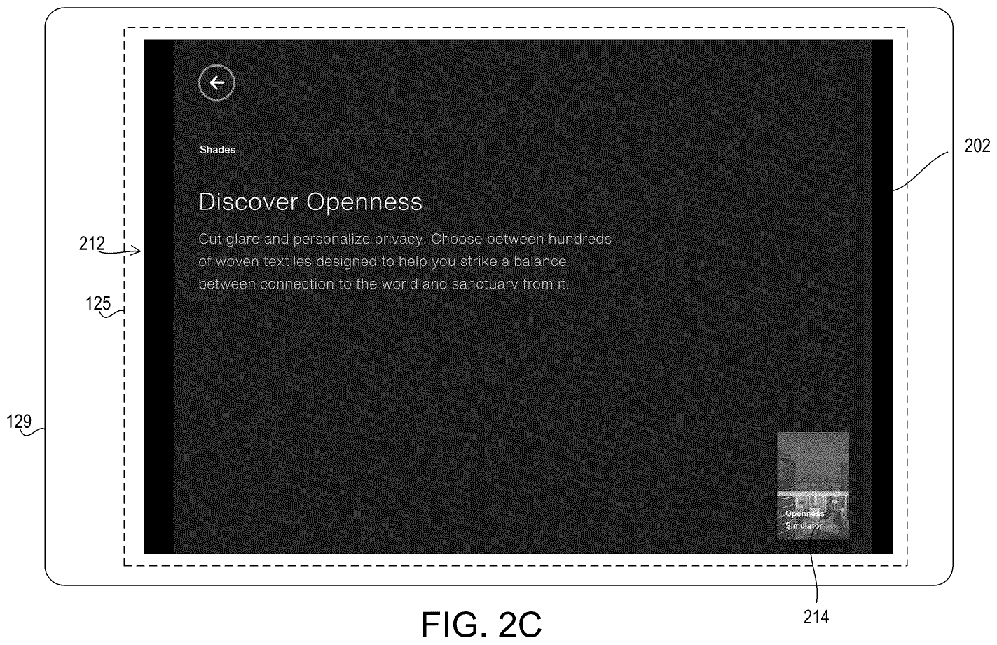

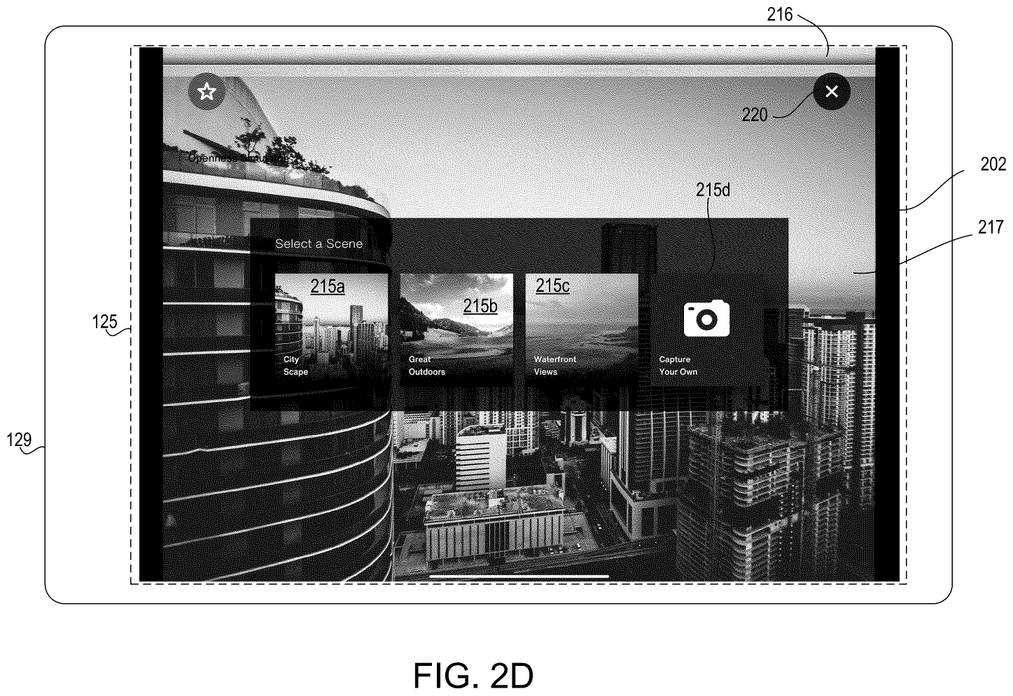

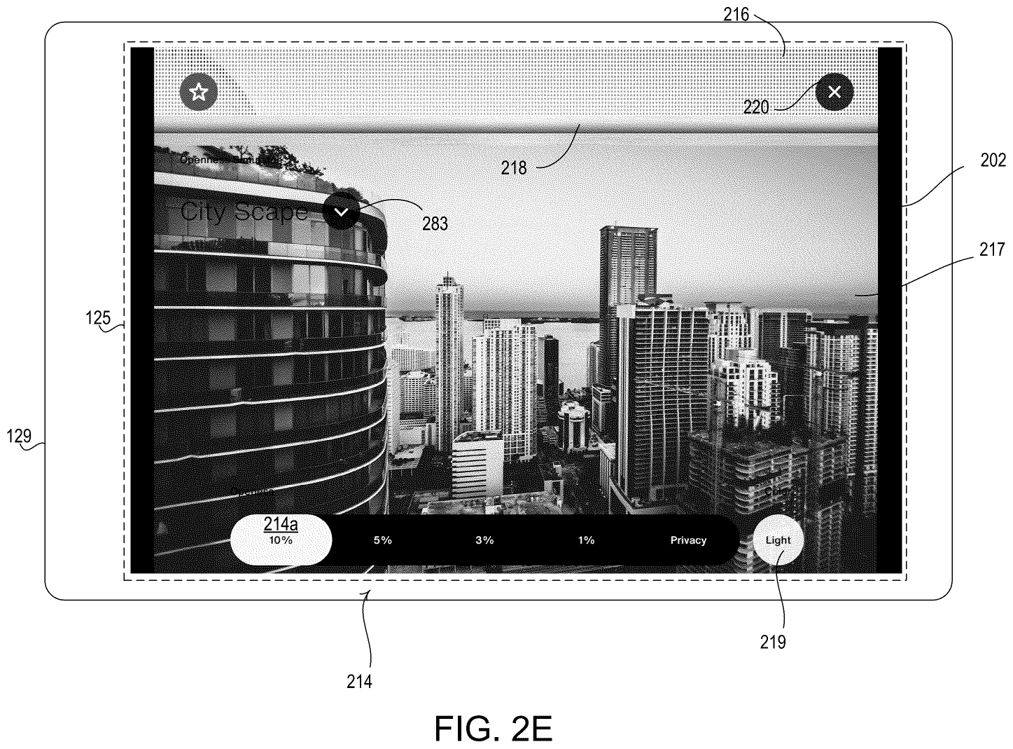

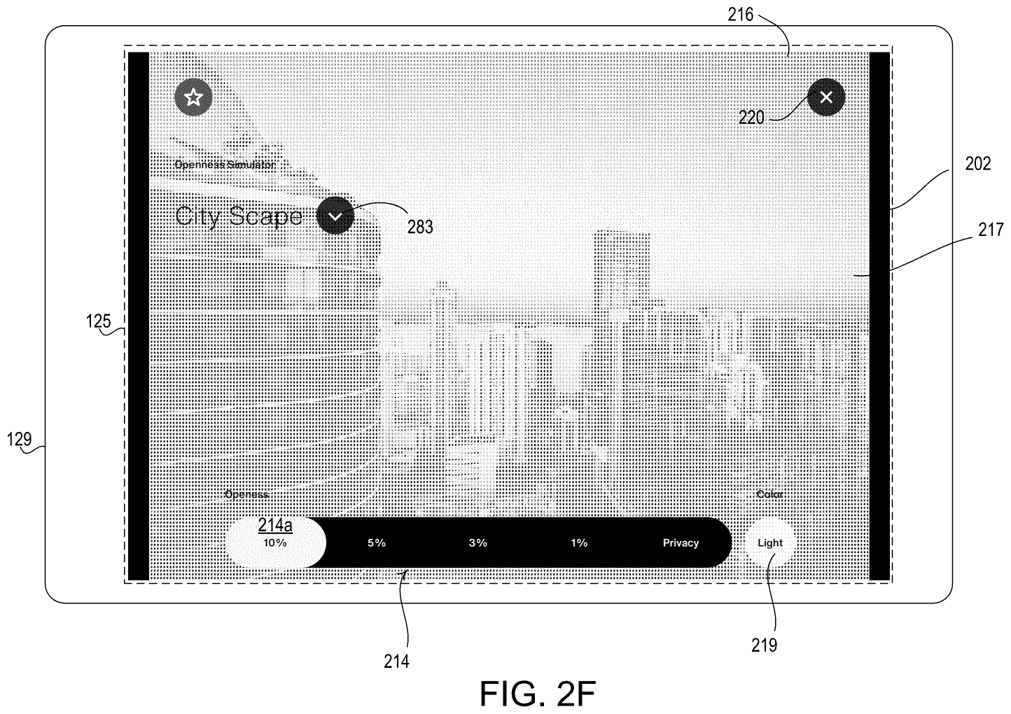

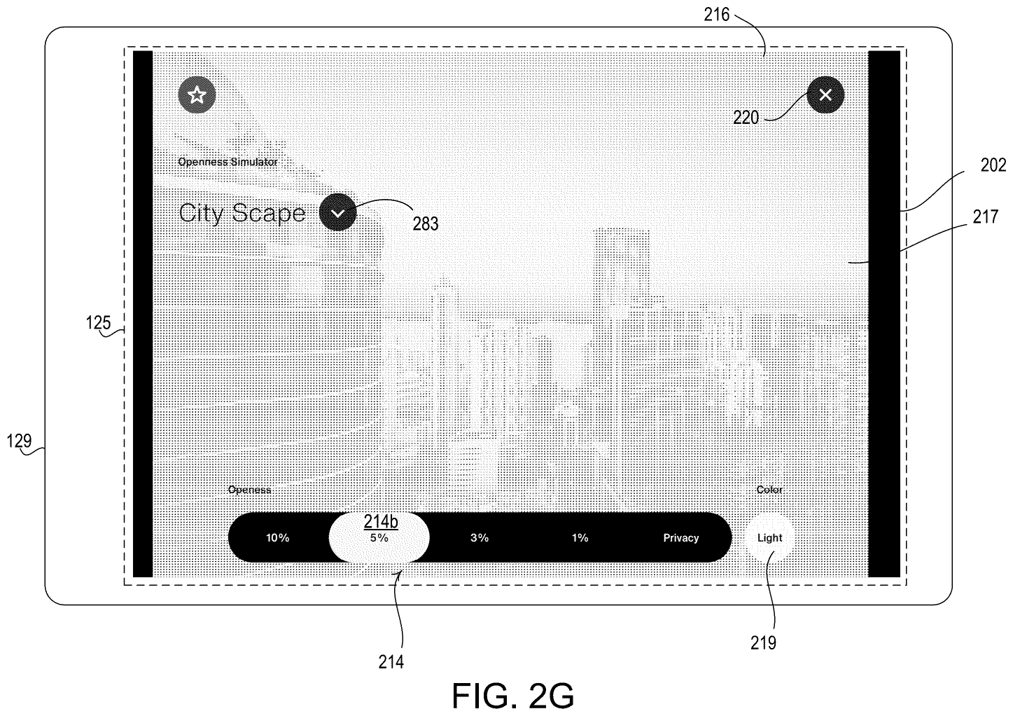

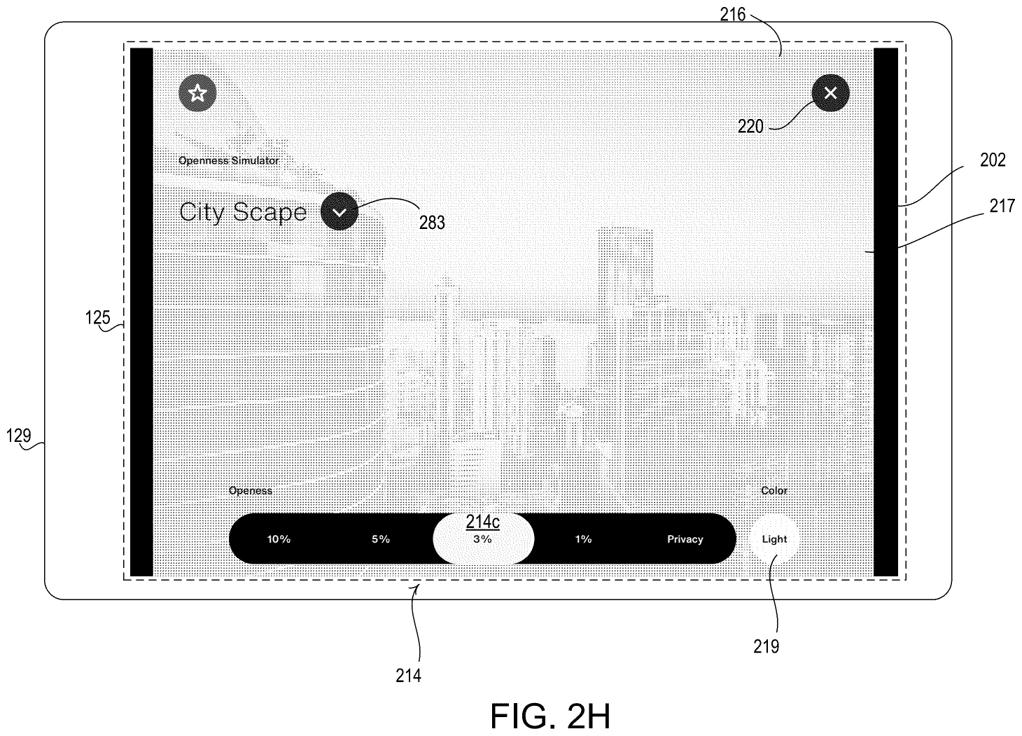

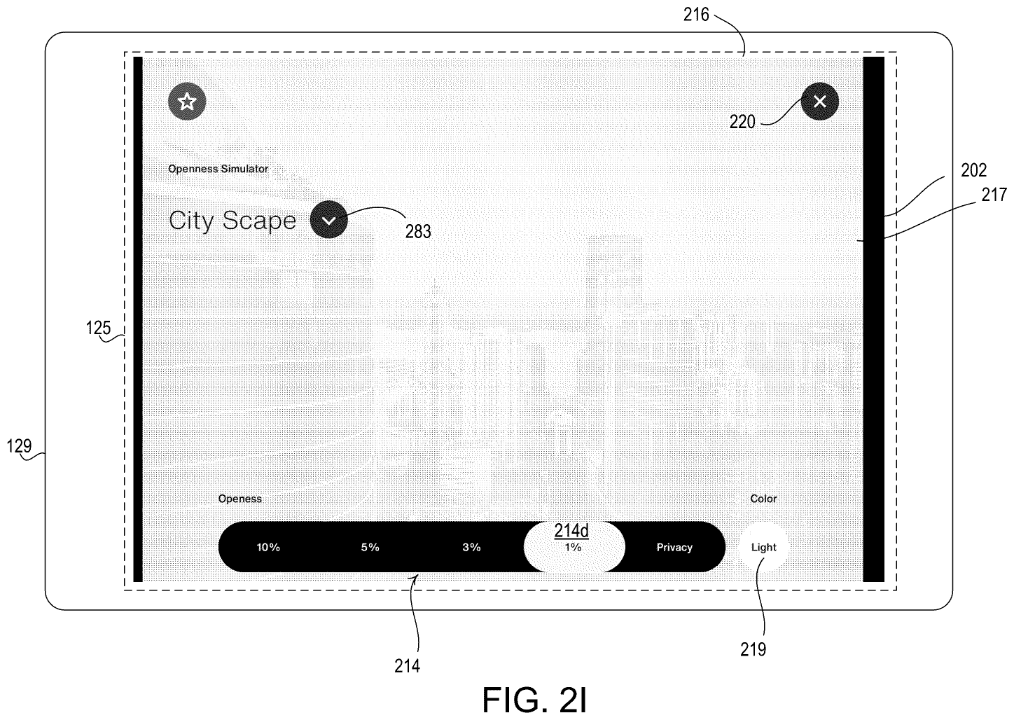

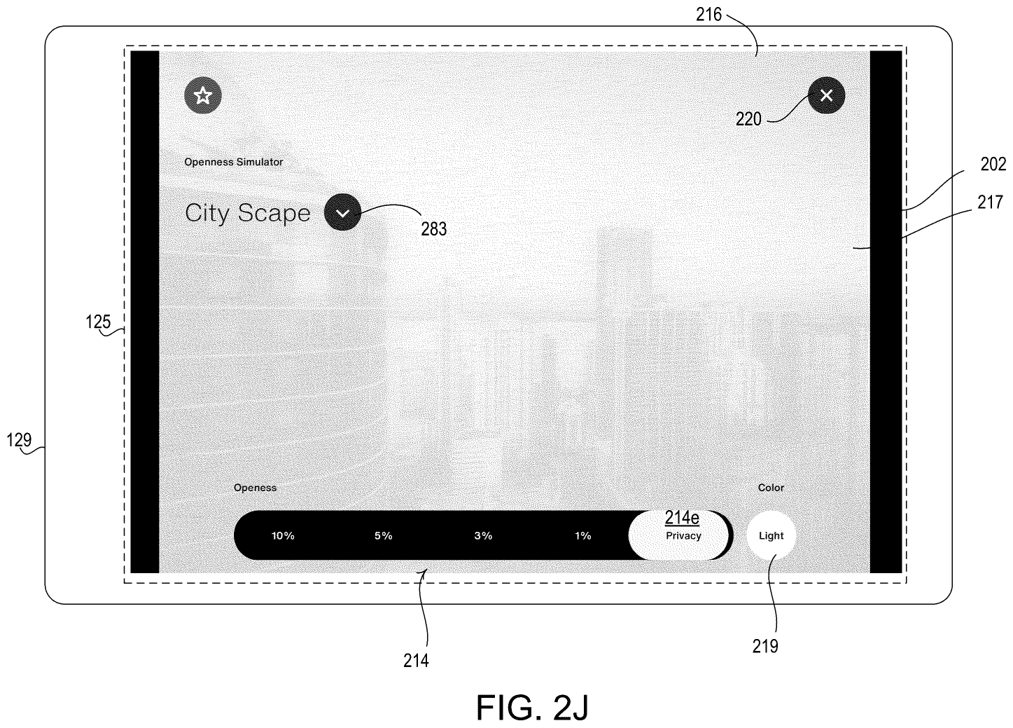

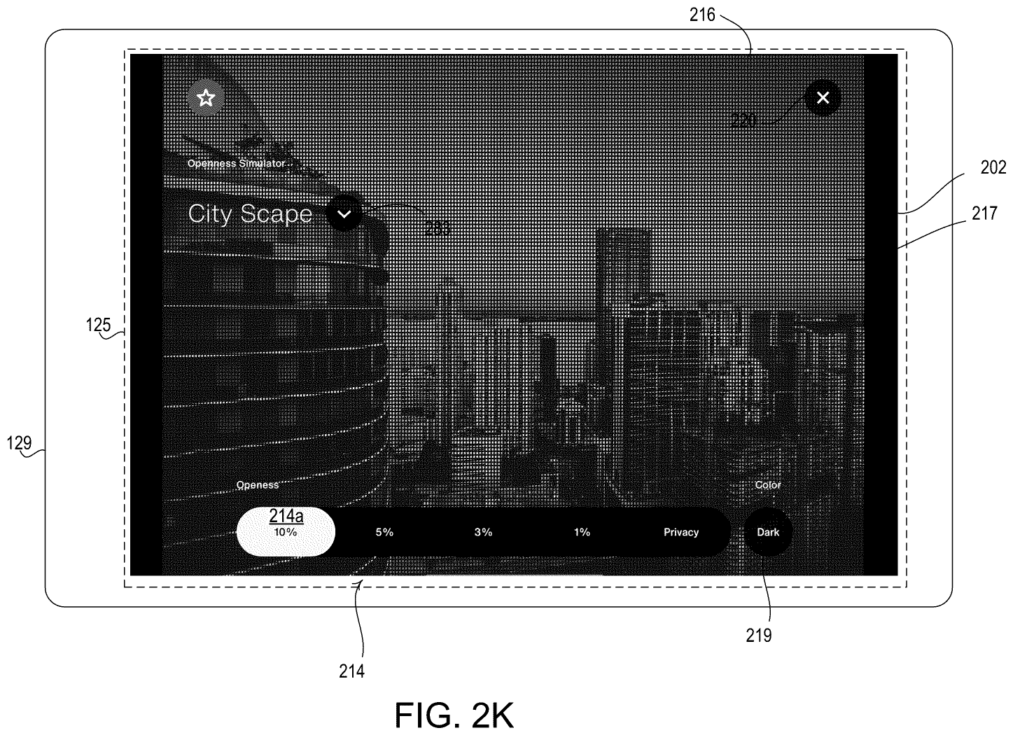

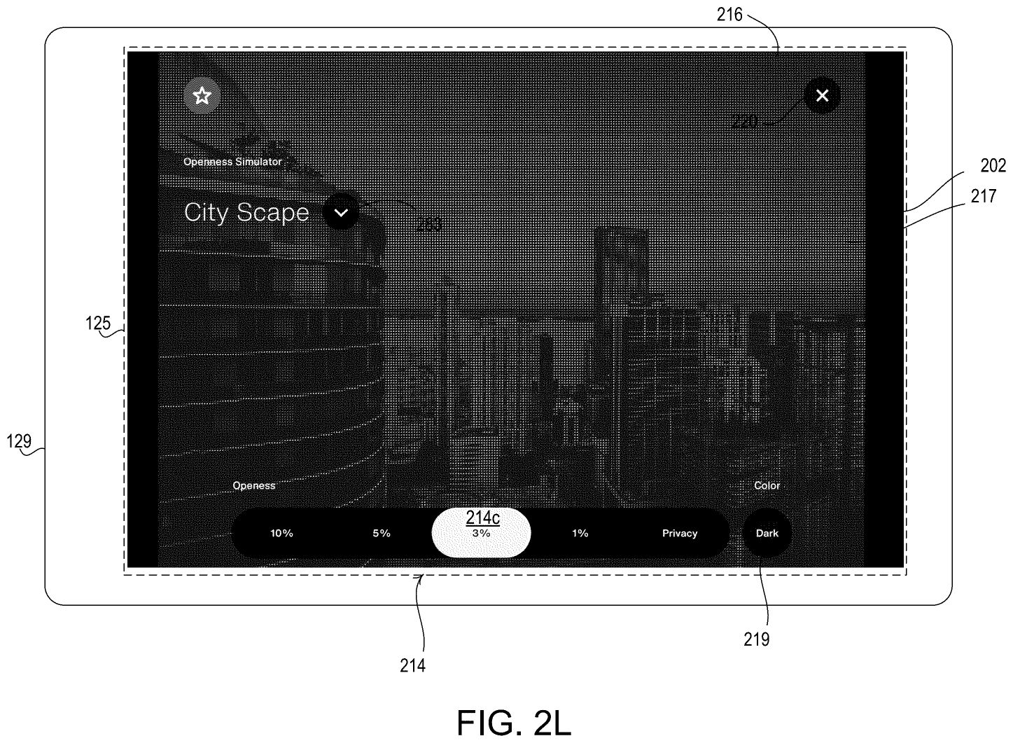

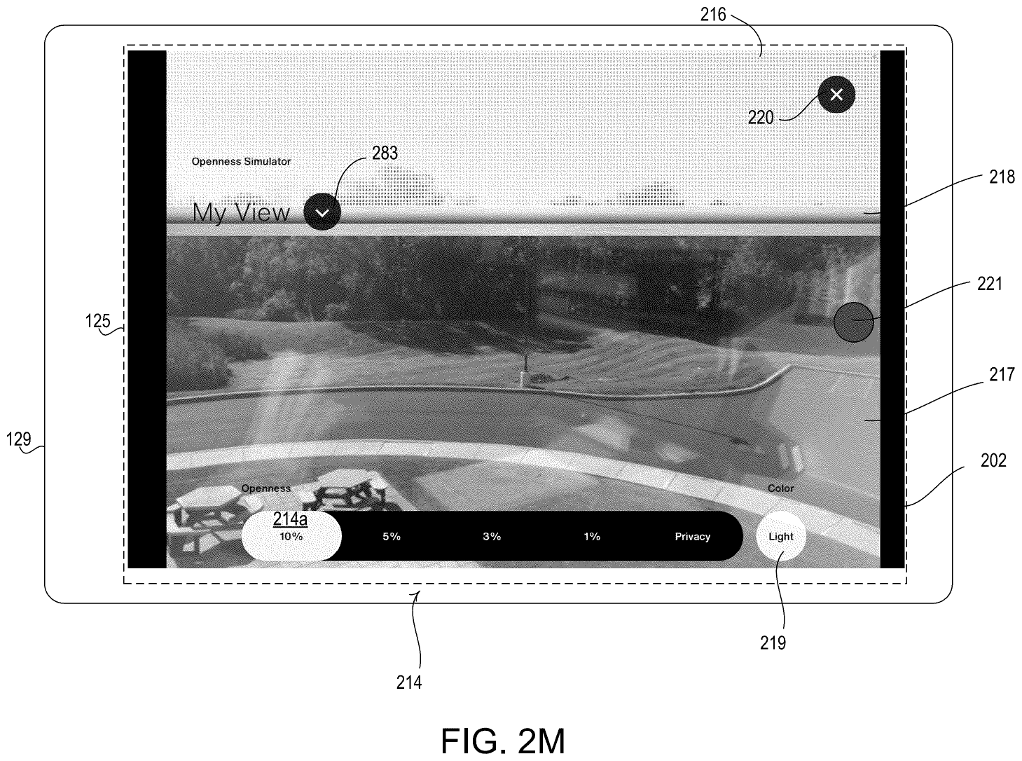

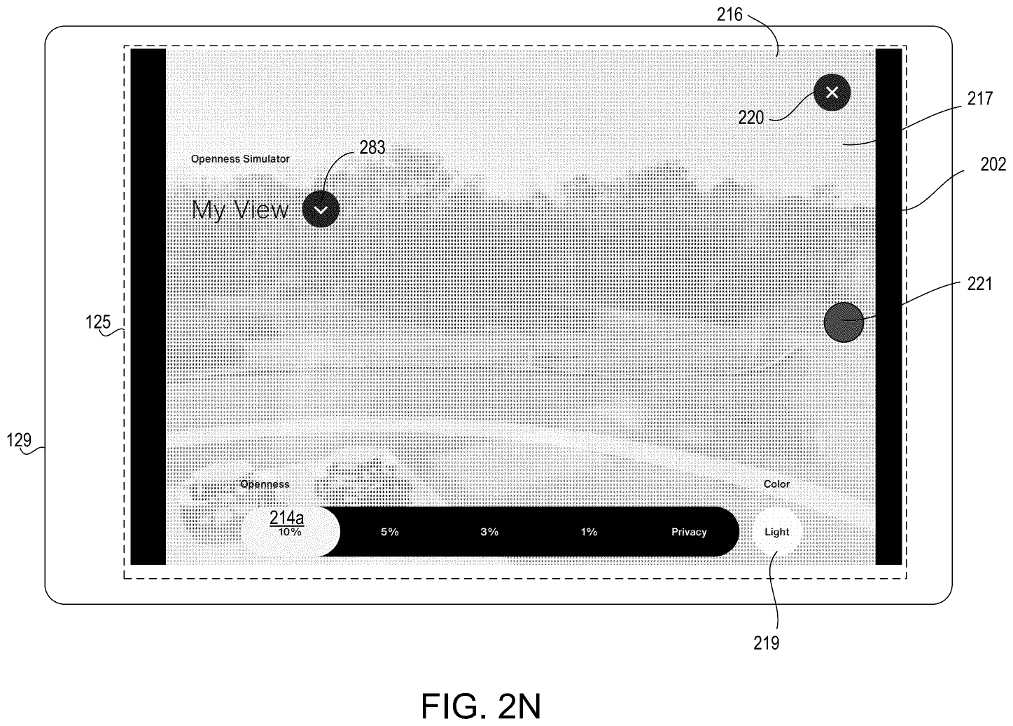

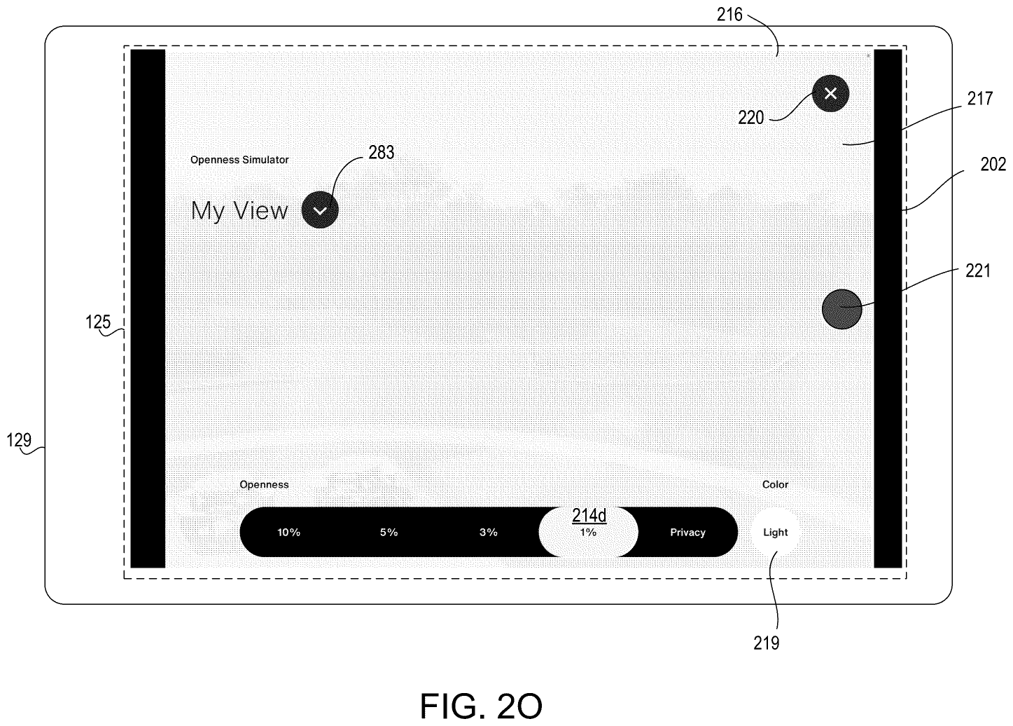

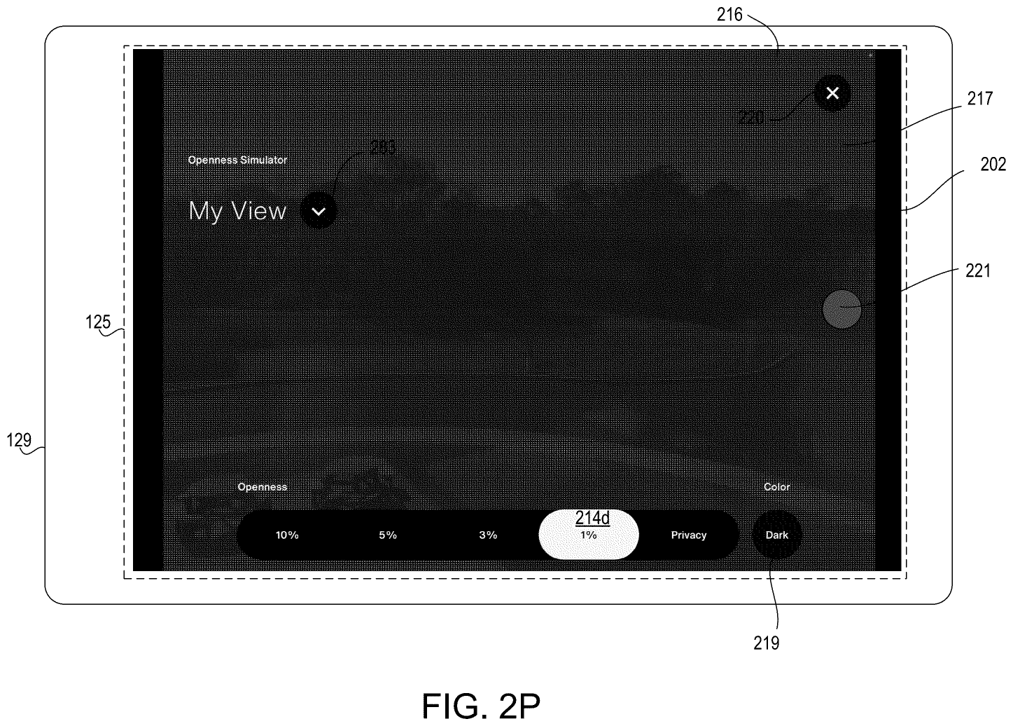

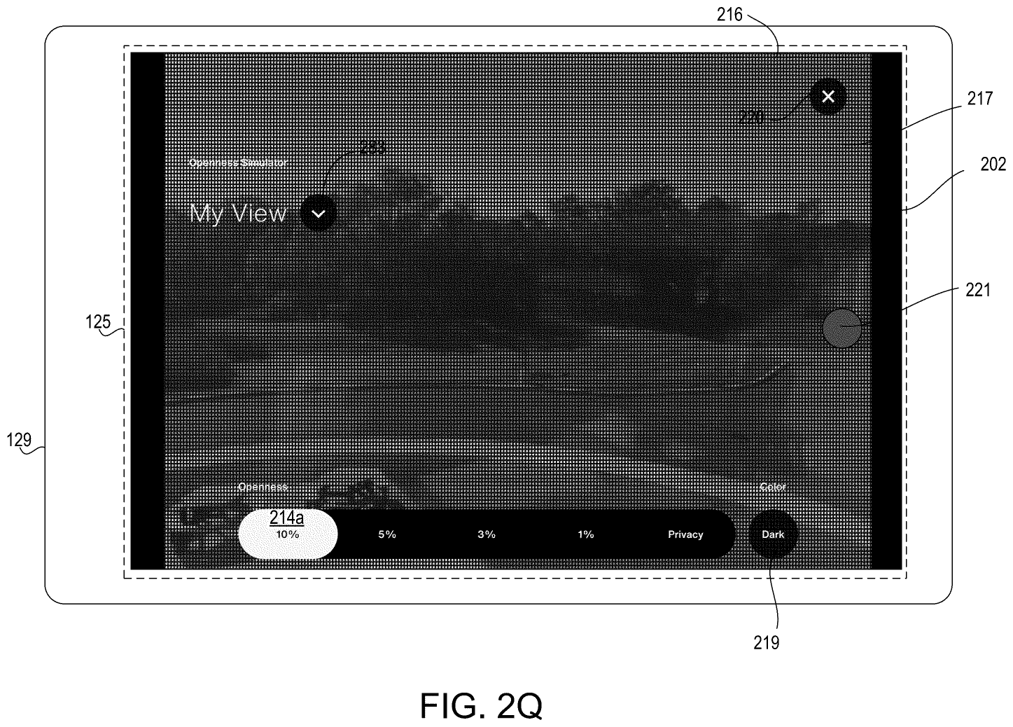

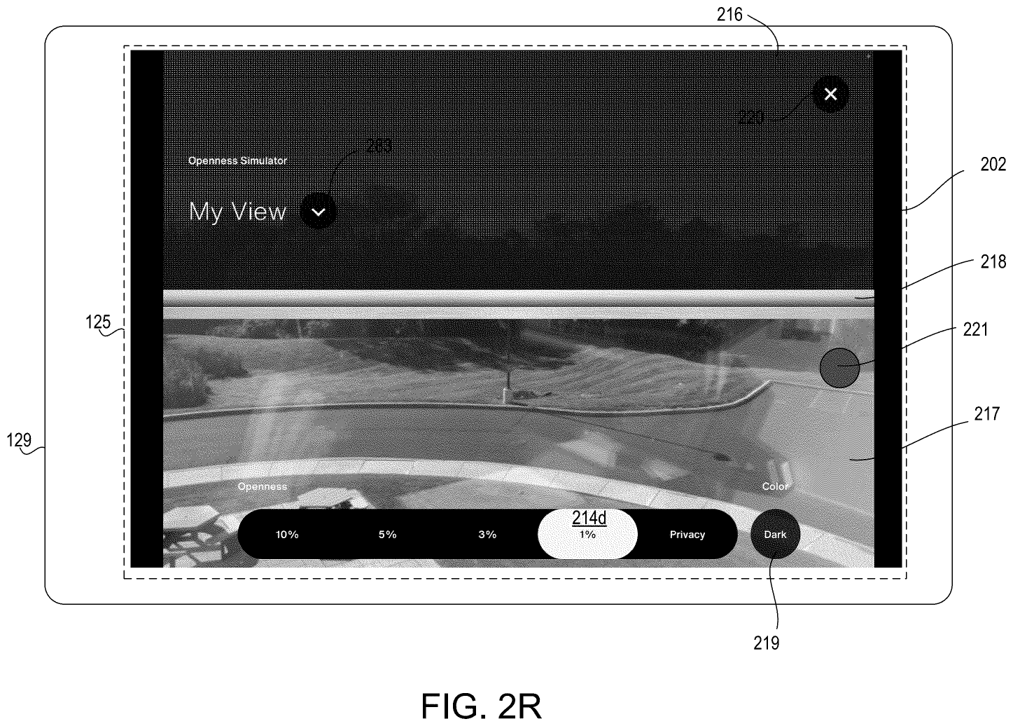

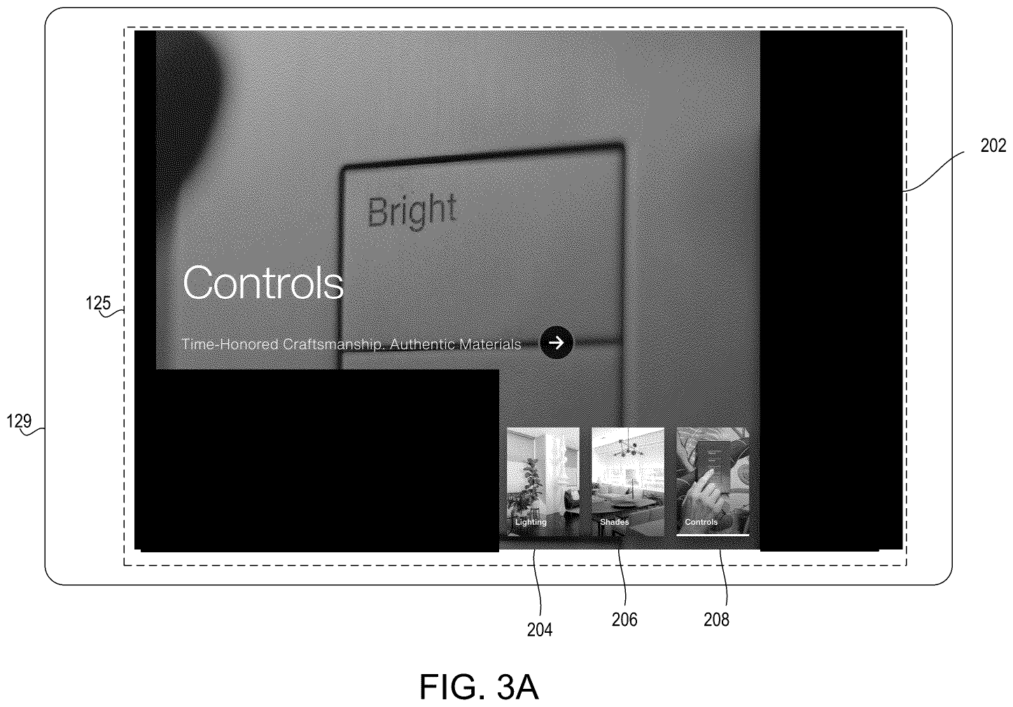

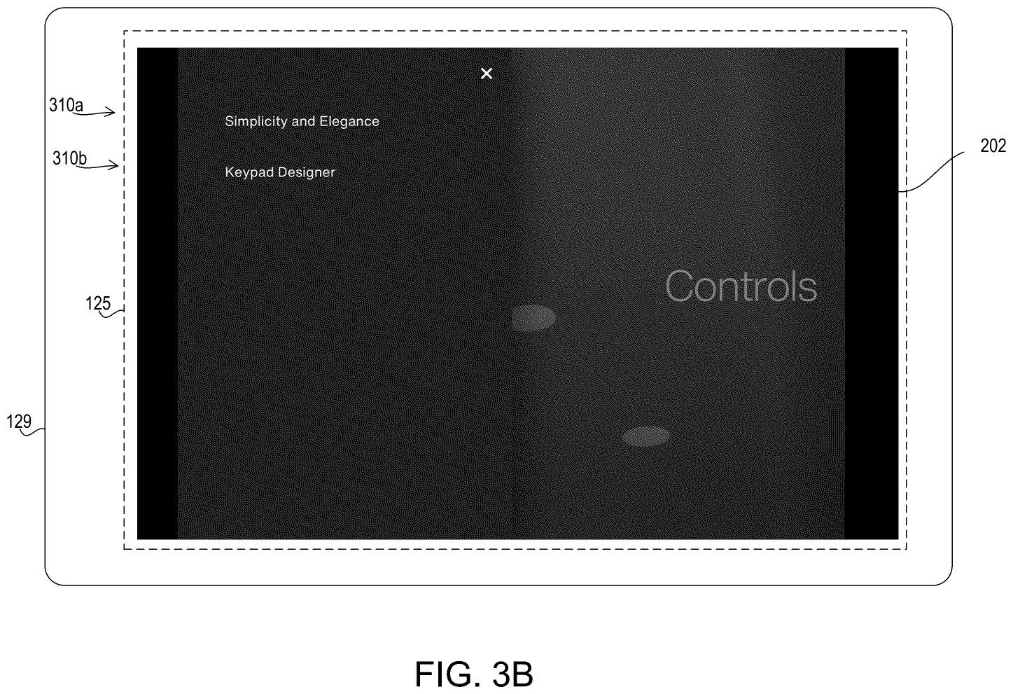

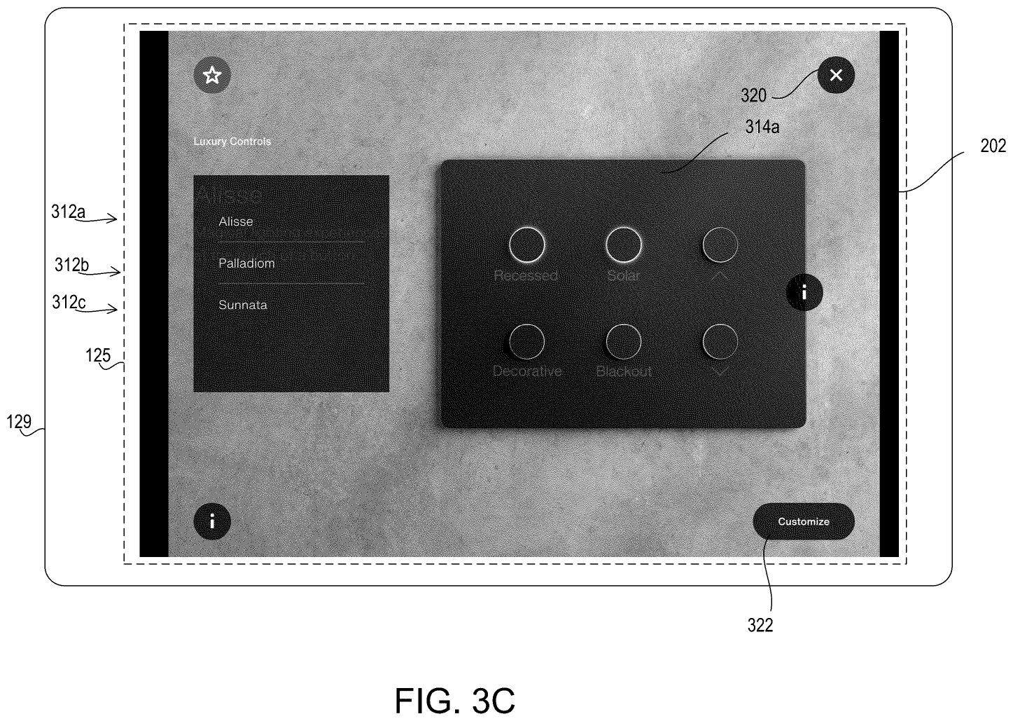

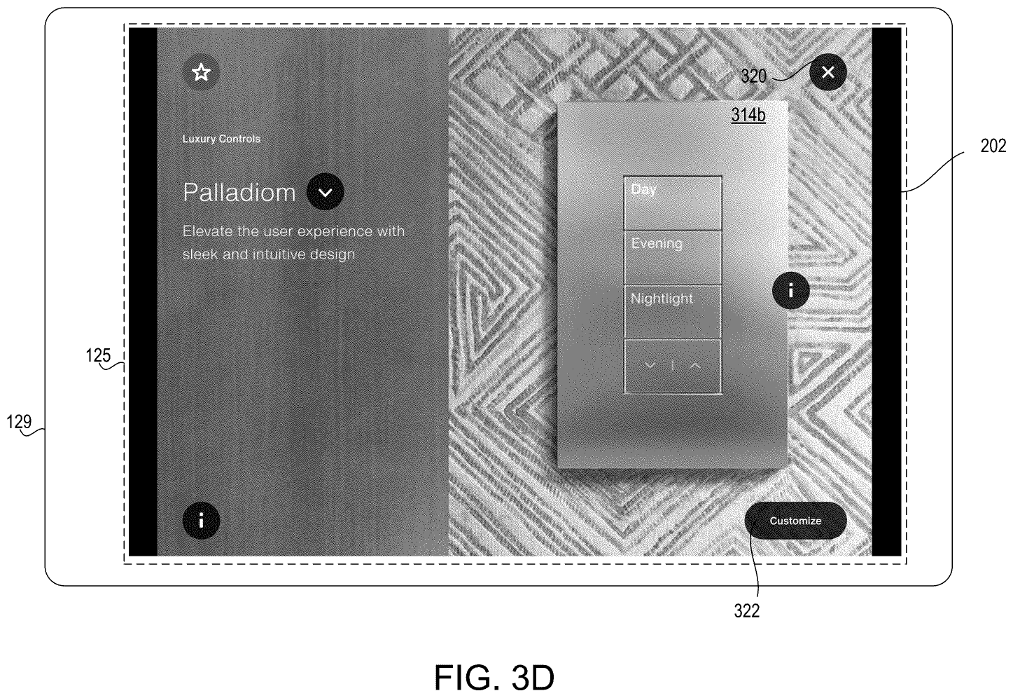

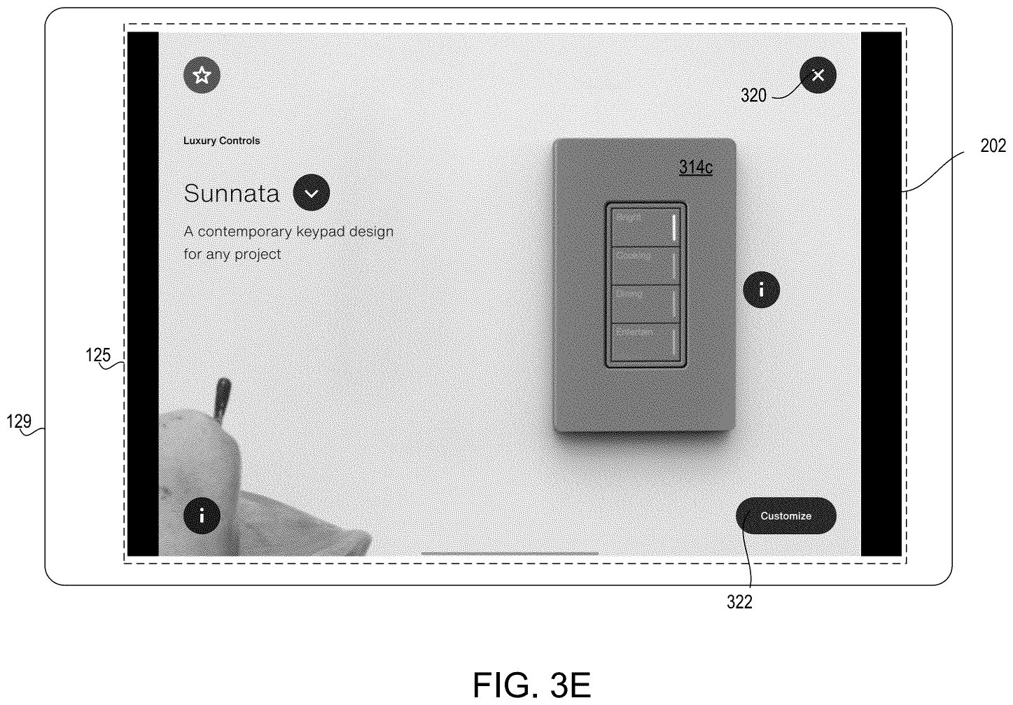

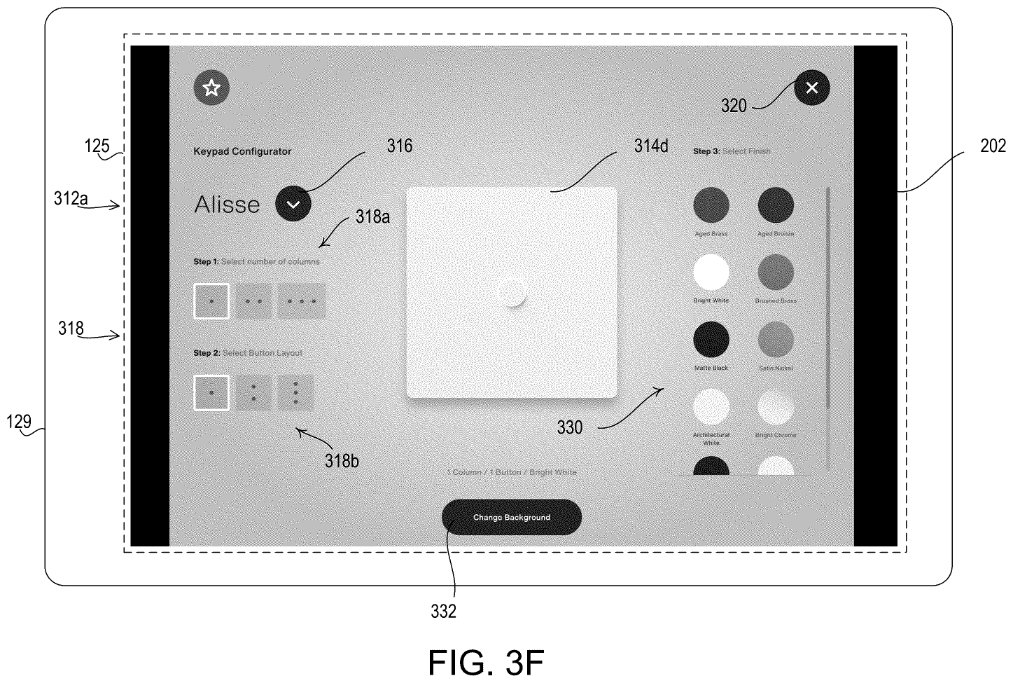

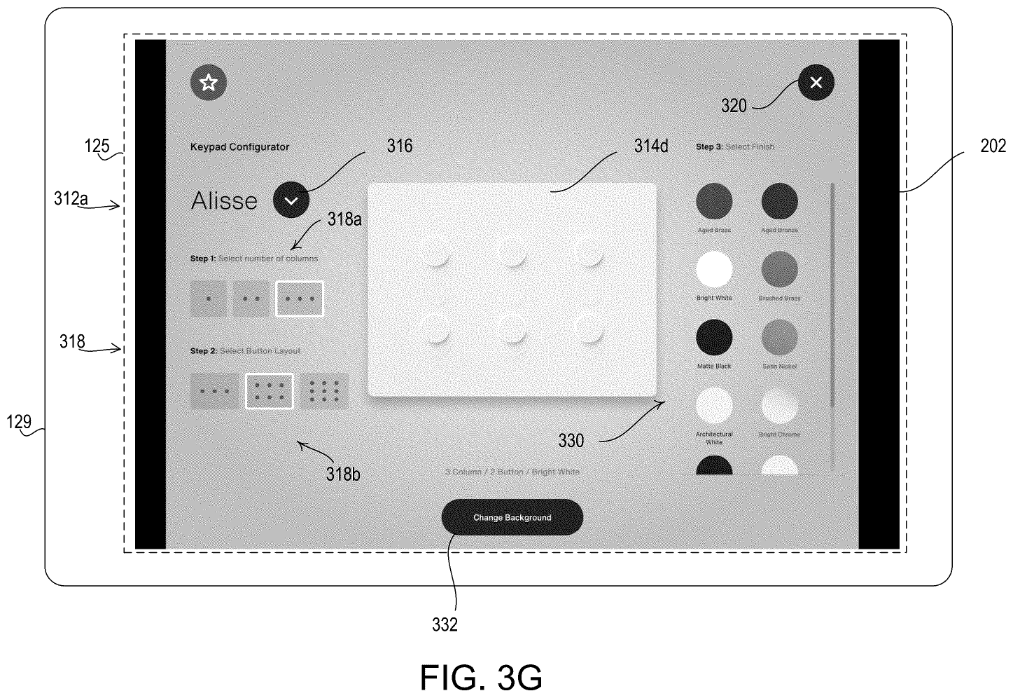

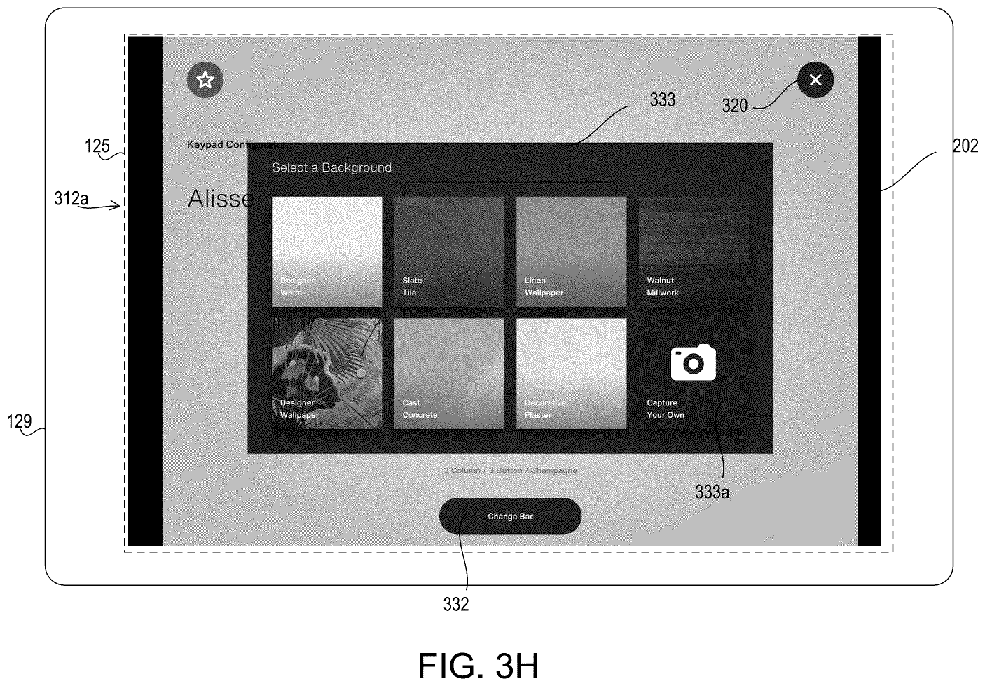

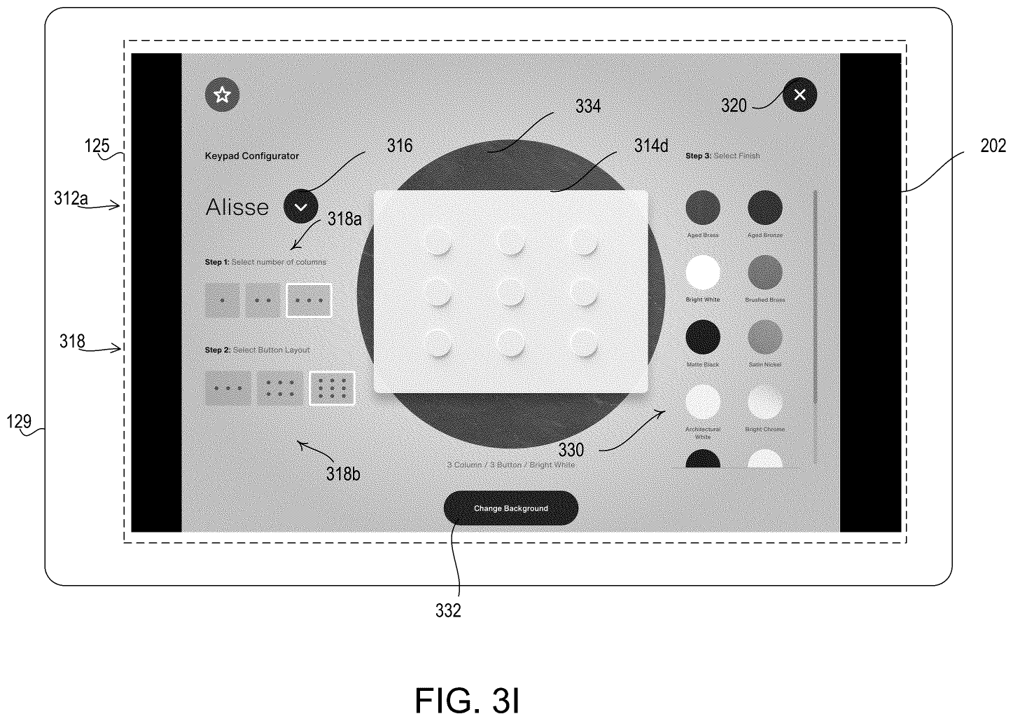

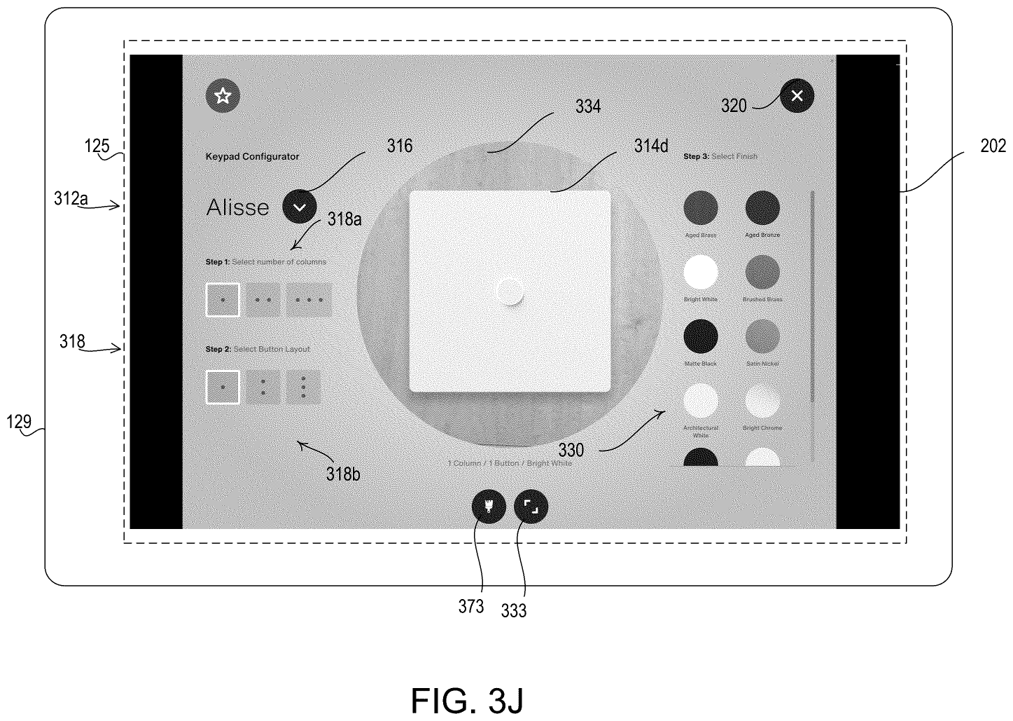

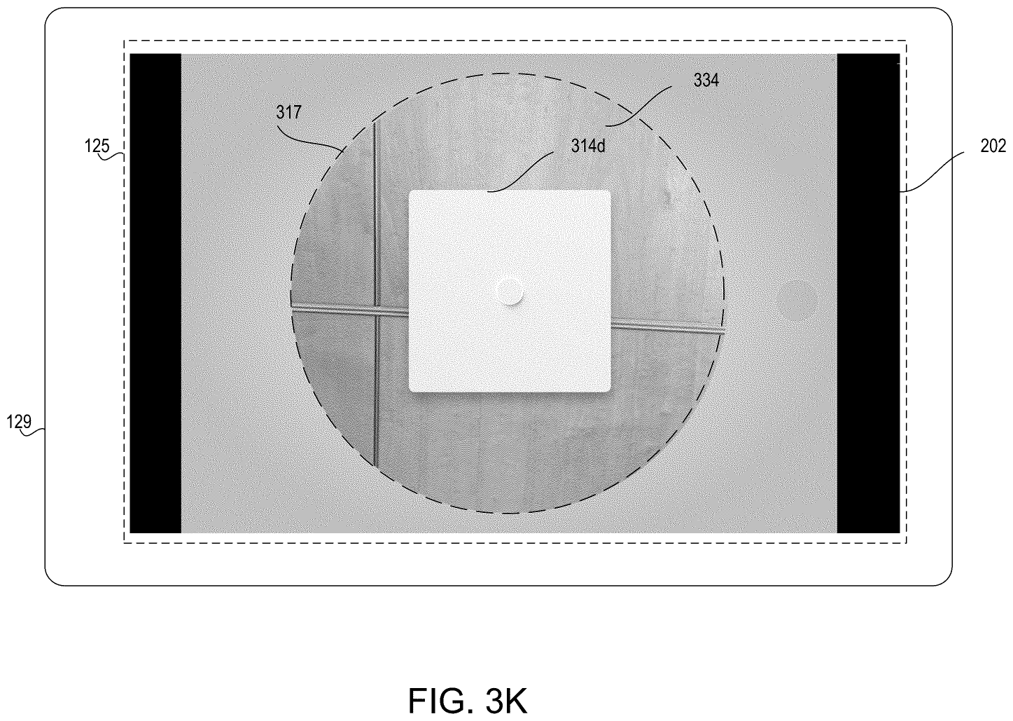

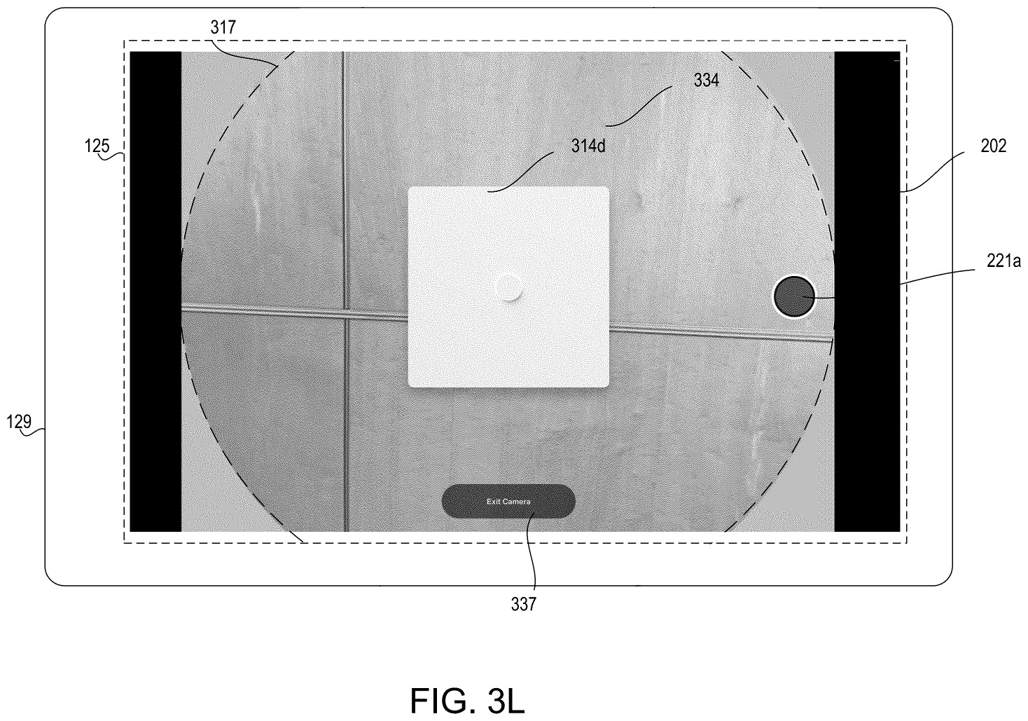

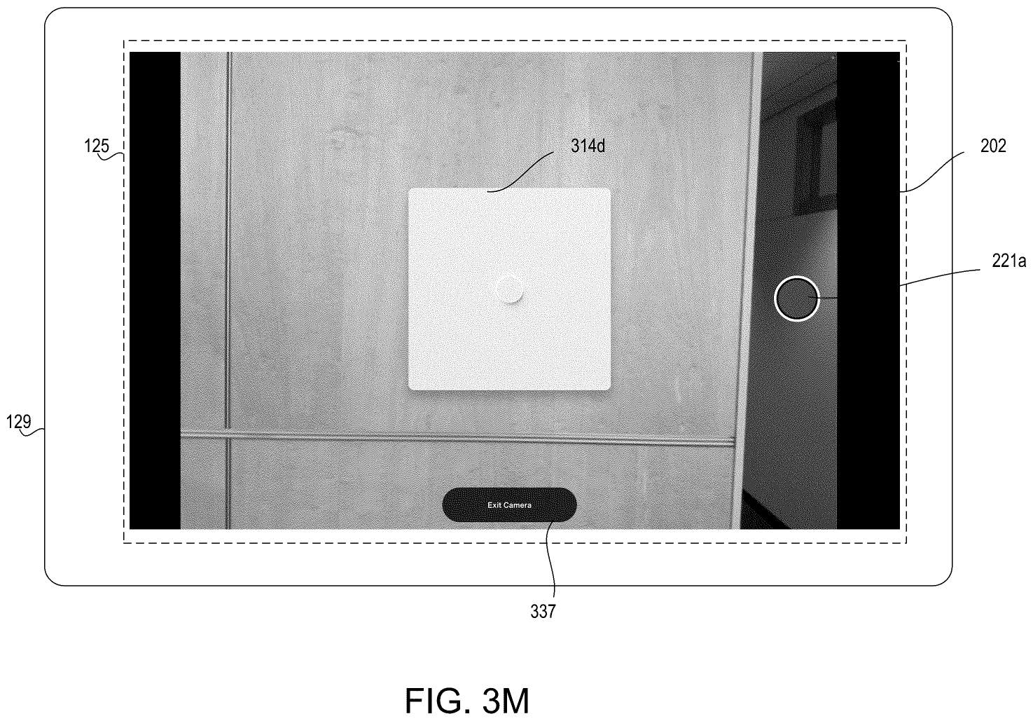

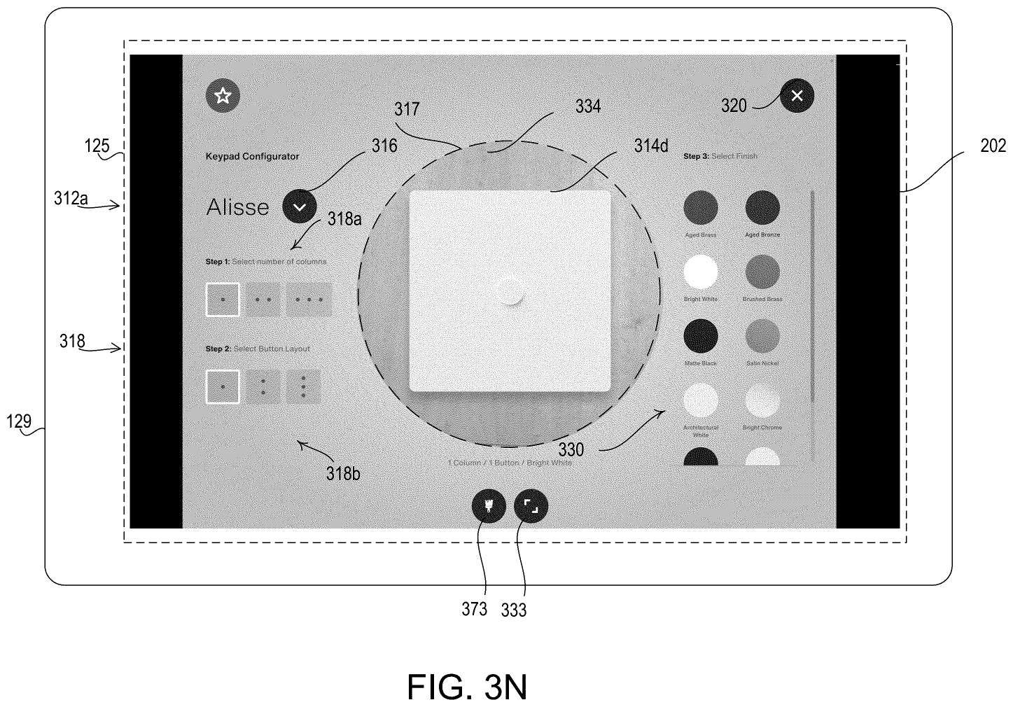

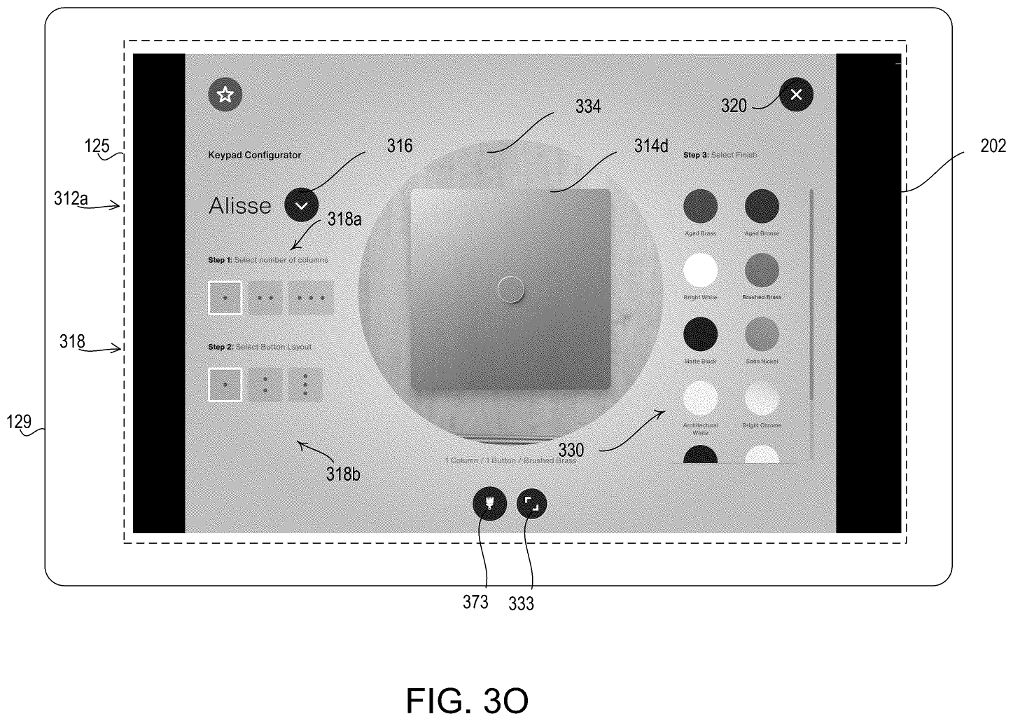

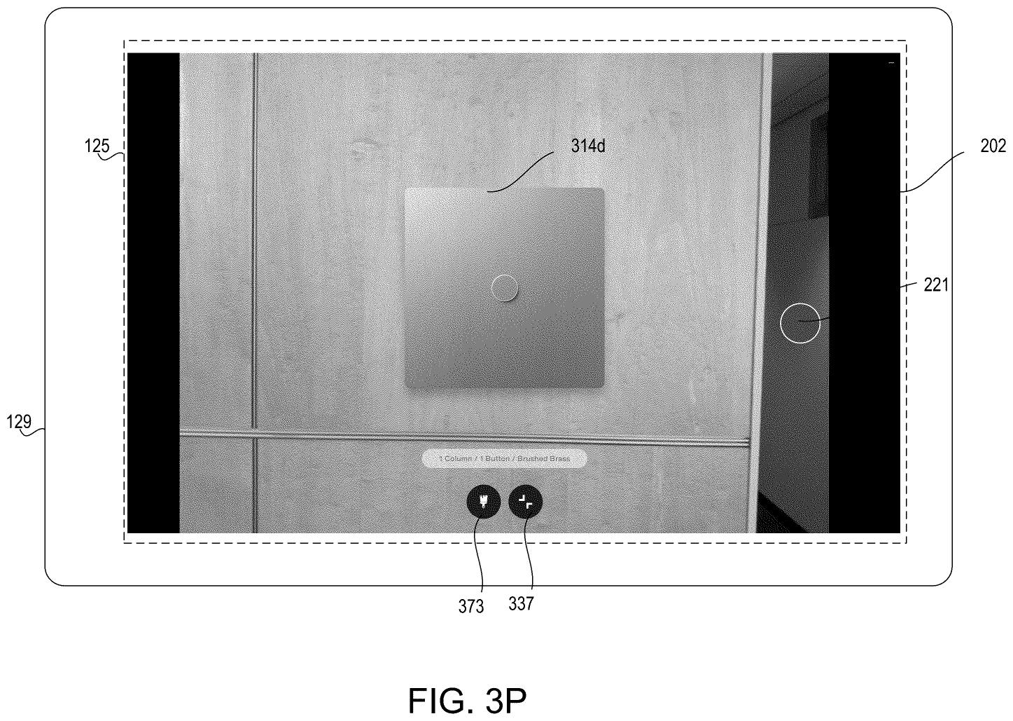

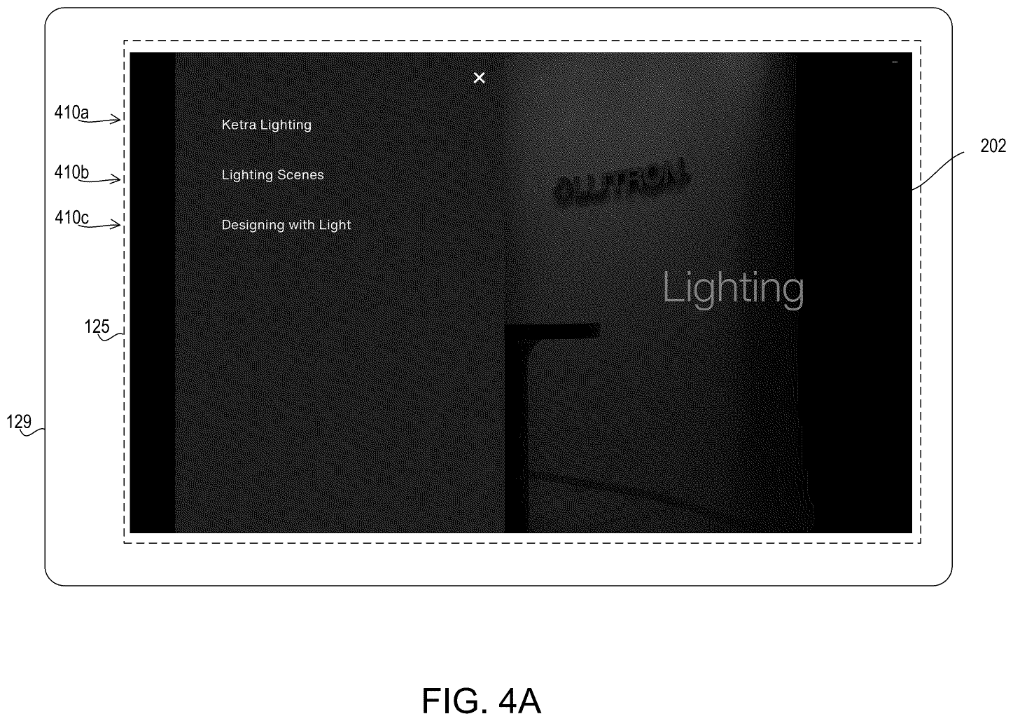

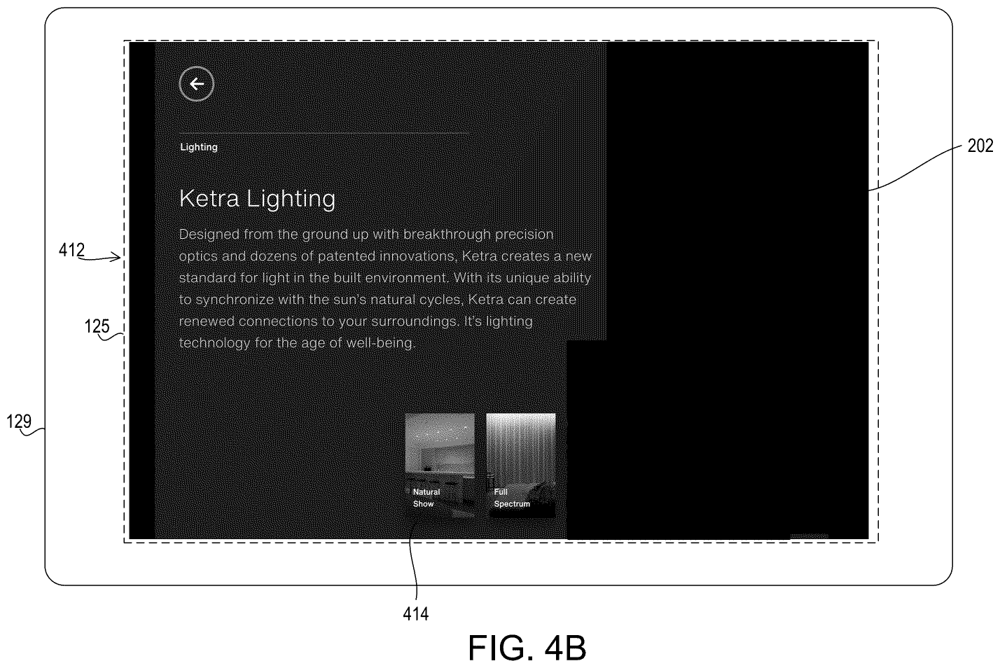

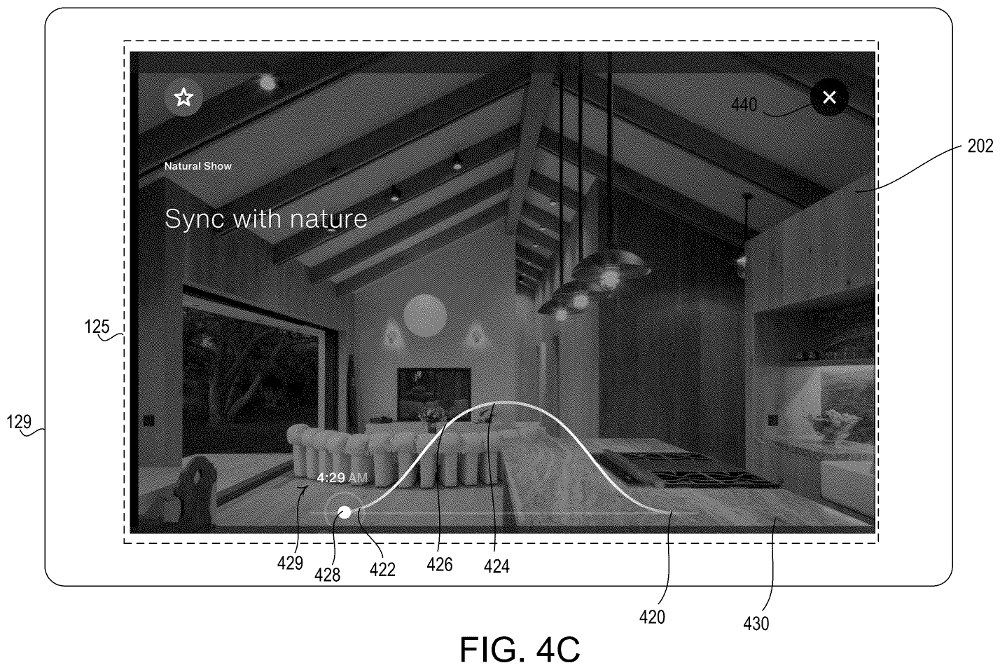

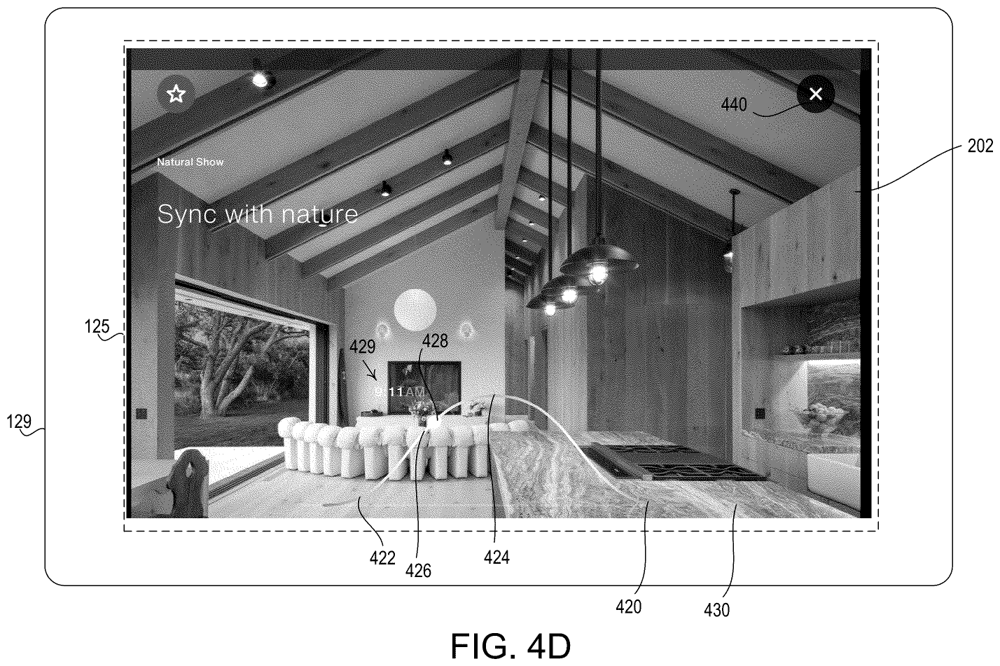

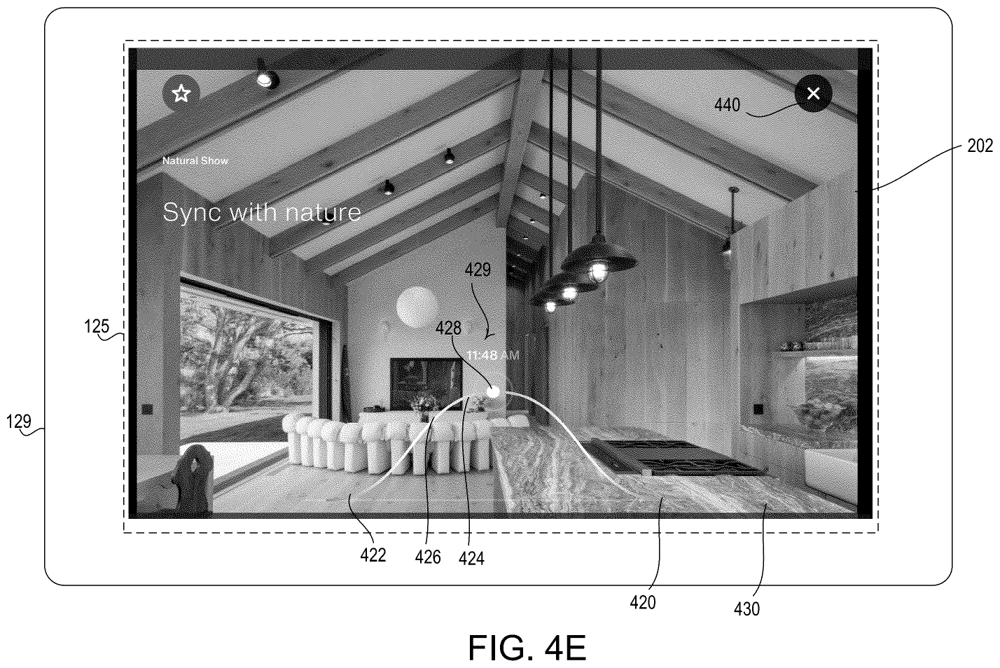

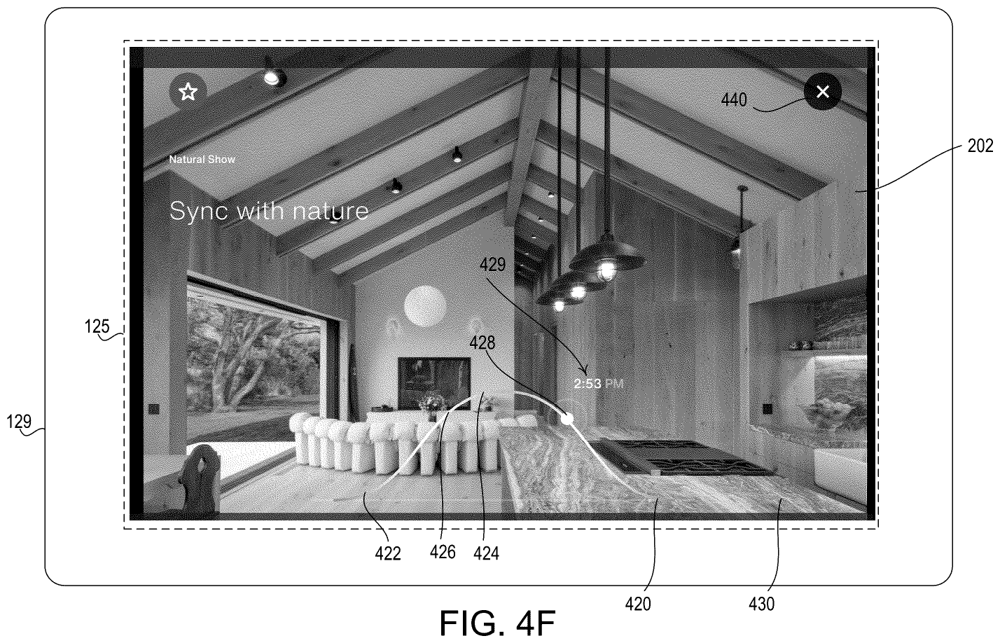

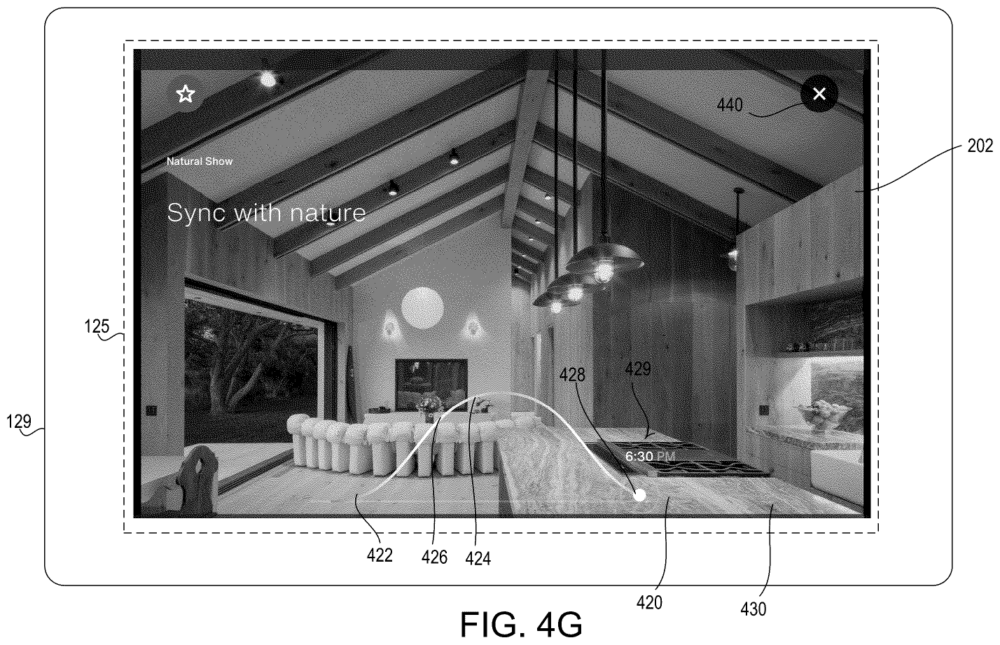

The control/configuration application may provide various graphical user interfaces on the user device 129 for simulating various components of the load control system 100 to the user 133, as described herein. FIGS. 2A-2R illustrate an example of one or more graphical user interfaces for simulating one or more features of a motorized window treatment and/or a covering material of the motorized window treatment, such as motorized roller shades 140 shown in FIGS. 1A-IC. FIGS. 3A-3P illustrate an example of one or more graphical user interfaces for simulating one or more features of a keypad, a dimmer switch, or a remote control device, such as keypad device 150, dimmer switch 120, or remote control device 152 shown in FIGS. 1A and 1C. FIGS. 4A-4G illustrate an example of one or more graphical user interfaces for simulating one or more features of a lighting control system configured to control various color settings, such as CCT settings, full color settings, and/or vibrancy settings affecting color saturation, over time (e.g., via natural show or natural lighting settings) to emulate a sunrise and/or sunset, for example.

As shown in FIG. 2A, the user device 129 may display a graphical user interface 202 on a display 125. The graphical user interface may be displayed via a simulation application that may be executed to simulate components of a load control system to a user. The simulation application may be a part of the control/configuration application. Though provided as a single graphical user interface 202, different portions of the graphical user interface 202 may be displayed in different graphical user interfaces or display screens thereon.

The graphical user interface 202 may display icons 204, 206, 208 for selecting by a user different portions, components, or subsystems within the load control system. For example, the icon 204 may be actuated by a user for selecting portions or components of a lighting control system. The icon 206 may be actuated for selecting portions or components of a motorized window treatment or shade control system. The icon 208 may be actuated for selecting portions or components of control devices in the load control system, such as a keypad device, a dimmer, or remote control device, for example.

In response to actuation of the icon 206, the graphical user interface 202 may display one or more functions 210a-210d, as shown in FIG. 2B, for displaying information related to a covering material of the motorized window treatment that may be provided via the display 125. For example, the one or more functions 210a-210d may include a function 210b for providing information related to openness factor of different covering materials installed in a motorized window treatment. Though the graphical user interface 202 may provide information related to the openness factor of different covering materials, the graphical user interface 202 may provide information related to other characteristics of a covering material, such as a visible light transmittance, for example. In response to actuation of the function 210b, or an icon displayed therefor, the graphical user interface 202 may display information about the feature and/or options related to the feature. For example, the graphical user interface 202 may display information 212, as shown in FIG. 2C, that describes the selected feature related to openness factor of covering materials installed in the motorized window treatment. The information 212 may describe that the openness factor may relate to an area of open space and/or an amount of fabric for the covering material. The information 212 may describe that the openness factor may define the ratio of area of open space to total area of the covering material and open area and/or other information related to how the openness factor is measured or quantified. The information 212 may describe that the color and/or the openness factor of the covering material may affect the visible light transmittance of the covering material. For example, a more open weave and/or a lighter color for the fabric may allow more visible light transmittance of the covering material than a more closed weave and/or darker color for the fabric, which may result in more visible light in the space and/or a greater view of objects through the fabric. The information 212 may describe that darker colors of the covering material may be easier to view through than lighter colors of the covering material having the same openness factor.

The graphical user interface 202 may include an icon 214 configured to provide an openness factor simulator on the display 125 of the user device 129. Though the icon 214 is displayed with the information 212, the icon 214 may be displayed on a screen having another configuration. For example, the openness factor simulator may be provided directly in response to the actuation of the function 210b related to openness factor of different covering materials or another icon displayed on another screen of the graphical user interface 202.

FIG. 2D shows an example of the graphical user interface 202 providing an openness factor simulator for simulating the openness factor on the display 125 of the user device 129 (e.g., in response to the actuation of the icon 214 of FIG. 2C). As shown in FIG. 2D, the openness factor simulator may provide one or more icons 215a-215d of scenes or views that may be actuated for displaying an image 217 over which a graphical representation of a covering material 216 may be displayed. The different scenes may include different colors to illustrate the effect of different openness factors, levels of covering material, and/or fabric colors on different colors in the user environment. Though not shown, a graphical representation of a motorized window treatment itself may also be displayed (e.g., at the top of the graphical representation of the covering material 216). The openness factor simulator may be exited in response to actuation of the icon 220 and/or the graphical user interface 202 may revert to displaying an earlier screen.

The icons 215a-215c may represent predefined scenes. An actuation of one of the icons 215a-215c may cause the openness factor simulator to display the image of one of the predefined scenes. For example, in response to the actuation of the icon 215a, the openness factor simulator may display an image 217 that corresponds to the icon 215a, as shown in FIG. 2E. As shown in FIG. 2E, the graphical user interface 202 may include an icon 283 that may cause the simulation application to revert back to an earlier screen, as shown in FIG. 2D for example, to select another scene or view. As shown in FIG. 2D, the actuation of one of the icons 215d may allow the user to capture an image of a scene in the user's space via a camera of the user device 129 over which the graphical representation of the covering material 216 may be displayed, as shown in FIGS. 2M-2R. The images captured by the camera of the user device may be updated in response to changes in location or orientation of the user device 129 and/or changes in settings of load control devices (e.g., lighting control devices) already installed in the load control system to illustrate the effect of different openness factors, levels of covering material, and/or fabric colors in response to changes in the user environment.

As shown in FIGS. 2E-2R, the representation of the covering material 216 over the selected image or images may simulate an increased or decreased level (e.g., raised/lowered position) of the covering material 216. The representation of the covering material 216 may be overlaid on top of the image 217. The location of the representation of the covering material 216 may be adjusted to simulate an adjustment in a position of a window treatment fabric in the space. Different portions or percentages of the image 217 may be covered by the representation of the covering material 216 to represent different levels of control of the covering material 216 on a motorized window treatment. As shown in FIG. 2E, the openness factor simulator may also provide a graphical representation of a hembar 218 at an end (e.g., bottom and/or top) of the graphical representation of the covering material 216. The graphical representation of the hembar 218 may indicate a level of the end of the graphical representation of the covering material 216. The user may raise or lower the graphical representation of the covering material 216 by selecting a location of the graphical representation of the hembar 218 and/or the graphical representation of the covering material 216 and drag the graphical representation to different levels to simulate different levels of a covering material of a motorized window treatment in a space after installation. Additionally, or alternatively, the graphical user interface 202 may overlay buttons (e.g., raise/lower buttons) on the image 217 for adjusting the graphical representation of the covering material 216 and/or hembar 218 to represent different levels of a covering material of a motorized window treatment. Though an example is provided for adjusting the representation of the covering material 216 using a location of a graphical representation of a hembar 218 on the bottom of the graphical representation of the covering material 216 (e.g., a top down shade), the graphical representation may simulate a bottom-up shade, such that the graphical representation of the hembar 218 is at the top of the covering material 216 on the display 125 and/or lowers to the bottom of the display 125. Additionally, the graphical representation of the hembar 218 may be displayed at one or more sides (e.g., left or right side) of the graphical representation of the covering material 216 (e.g., to represent a drapery or other window treatment).

As also shown in FIGS. 2E-2R, the openness factor simulator may provide one or more actuators 214 configured to simulate a different openness factor via the graphical representation of the covering material 216 in response to actuation of an actuator 214. The different actuators 214 may represent different levels of openness factors corresponding to a fabric or other covering material, which may be represented by a percentage or other ratio. For example, as shown in FIGS. 2E, 2F, 2K, 2M, 2N, and 2Q, the graphical user interface 202 may overlay the graphical representation of the covering material 216 with the identified openness factor identified by the actuator 214a (e.g., 10% openness factor) in response to the actuation of the actuator 214a. As shown in FIG. 2G, the graphical user interface 202 may overlay the graphical representation of the covering material 216 with the identified openness factor identified by the actuator 214b (e.g., 5% openness factor) in response to the actuation of the actuator 214b. As shown in FIGS. 2H and 2L, the graphical user interface 202 may overlay the graphical representation of the covering material 216 with the identified openness factor identified by the actuator 214c (e.g., 3% openness factor) in response to the actuation of the actuator 214c. As shown in FIGS. 2I, 2O, 2P, and 2R, the graphical user interface 202 may overlay the graphical representation of the covering material 216 with the identified openness factor identified by the actuator 214d (e.g., 1% openness factor) in response to the actuation of the actuator 214d. As shown in FIG. 2J, the graphical user interface 202 may overlay the graphical representation of the covering material 216 with the identified openness factor identified by the actuator 214e (e.g., privacy or less than 1% openness factor) in response to the actuation of the actuator 214e. The privacy or less than 1% openness factor may be zero percent openness factor or between zero and 1% openness factor. Though a predefined number of actuators 214 may be provided as an example, it will be understood that more or less actuators may be provided for changing the overlay the graphical representation of the covering material 216. In another example, the openness factor may be provided on a sliding scale within a range (e.g., one or more of 10% to 0%, 25% to 0%, 50% to 0%, 100% to 0%, etc.) that may allow the user to select or identify one or more values within the range. The graphical user interface 202 may update the overlay of the graphical representation of the covering material 216 dynamically in response to input from the user.

The selection of different openness factors may cause different graphical representations of the covering material 216 to be overlaid over the image 217. Each graphical representation of the covering material 216 at different openness factors may allow for a different portion of the image 217 to be displayed through the representation of the covering material 216 to simulate the openness factor of different covering materials installed in the space. The relative difference in the portion of the image 217 that is allowed to be displayed for different openness factors may correspond to the relative ratio of openness factors in actual material used in a window treatment. For example, after selection of an openness factor of 10%, 10% of the image 217 may be visible to the user through the graphical representation. Similar portions of the image may be displayed in response to selection of other openness factors. This may simulate a relative difference in view clarity or natural light allowed into a space by installation of covering materials having different openness factors in a space.

As further shown in FIGS. 2E-2R, the openness factor simulator may allow the user to select other characteristics for displaying the graphical representation of the of the covering material 216. For example, the graphical user interface 202 may overlay an actuator 219 for selecting a color of the graphical representation of the covering material 216. In response to the selection of a color via the actuator 219, the graphical representation of the covering material 216 may be updated with the selected color for being overlaid in the color over the image 217.

As shown in FIGS. 2E-2J and 2M-20, a lighter color (e.g., white or tan) may be selected for the graphical representation of the covering material 216 via the actuator 219. As shown in FIGS. 2K-2L and 2P-2R, a darker color (e.g., black) may be selected for the graphical representation of the covering material 216 via the actuator 219. Though a lighter color and darker color are provided as examples, any number of colors or ranges of colors and/or fabrics may be provided for selection by the user. As described herein, the color and/or the openness factor of the covering material may affect the visible light transmittance of the covering material. For example, a more open weave and/or a lighter color for the covering material may allow more visible light transmittance of the covering material than a more closed weave and/or darker color for the fabric, which may result in more visible light in the space and/or a greater view of objects through the fabric.

As shown in FIGS. 2M-2R, the image 217 over which the graphical representation of the covering material 216 may be displayed may be an image captured and/or generated by a camera of the user device 129. For example, as shown in FIG. 2D, the user may select an icon 215d to capture an image in the user's space via a camera of the user device 129 over which the graphical representation of the covering material 216 may be displayed. In response to the actuation of the icon 215d, the openness factor simulator may cause the graphical user interface to enter a camera mode to display an image 217 on the display 125 that is captured by the camera of the user device 129, as shown in FIG. 2M, or select a predefined image from a camera application on the user device 129. The use of the camera on the user device 129 may allow the simulation of a motorized window treatment and/or covering material in the physical space of the user. The use of the camera on the user device 129 may also allow the user to change the location or orientation of the user device 129 and/or change the settings of load control devices (e.g., lighting control devices) already installed in the load control system to illustrate the effect of different openness factors, levels of covering material, and/or fabric colors in the images captured by the camera in response to changes in the user environment.

The image 217 may be a predefined image retrieved from memory on the user device 129. For example, referring again to FIGS. 2M-2R, the image 217 may be taken by the camera in response to actuation of an icon 221. The image 217 may be stored in memory and/or selected by the user from one or more images. As another example, the image 217 may be automatically displayed in response to the actuation of the icon 221. As another example, the image 217 may be one of a series of images (e.g., displayed as a video) on the display 125 of the user device 129. The image 217 being displayed may be one of a series of images recorded live by the camera on the user device 129 in response to the actuation of the icon 221. As a further example, the image by a live image that changes dynamically as the user moves the user device. The live images may be captured with the overlay of the covering material 216. While the image 217 or series of images are being displayed, the user may actuate one of the icons 214 for updating the openness factor of the visual representation of the covering material 216 being displayed over the image 217 or series of images. Similarly, the user may actuate the icon 219 to update the color of the visual representation of the covering material 216 being displayed over the image 217 captured by the camera. Further, the use may change the location or position of the visual representation of the covering material 216 being displayed over the image 217 captured by the camera.

In another example, the images may be captured by the camera of the user device 129 in the camera mode and displayed on the graphical user interface 202 without the covering material 216. While the series of images are being displayed, the user may actuate the icon 221 to capture the image, such that the image can be selected or discarded for capturing another image. After the image is taken and/or selected, the icon 221 may disappear to allow for control of the location of the covering material 216, the selection of the color, and/or the selection of the openness factor of the covering material on the captured image 217.

As shown in FIGS. 2M-20, the location of the covering material 216 may be adjusted (e.g., to a raised/lowered position) and the openness factor may be changed after the adjustment to the covering material location to allow the user to visualize different openness factors of the covering material. As shown in FIGS. 20 and 2P, a color of the covering material may be changed, while the openness factor is maintained, to allow the user to visualize a change in the color of the covering material with the same openness factor. As shown in FIGS. 2P-2Q, the openness factor may be updated after the color of the covering material has been changed to allow the user to visualize the different openness factors for the updated color of the covering material. As shown in FIGS. 2Q-2R, the openness factor may be changed when the location of the covering material is at different locations to allow the user to visualize the covering material having a different openness factor (or color) when the covering material is at different levels.

Referring again to FIG. 2A, the graphical user interface 202 may display an icon 206 that may be actuated for selecting portions or components of control devices like keypads, or dimmers, or remotes for example that may be simulated on the display 125 of the user device 129. Responsive to selection of icon 206, a graphical user interface like that shown in FIG. 3A may be displayed. In particular, FIGS. 3A-3P illustrate an example of one or more graphical user interfaces for configuring and/or simulating one or more features or characteristics of a control device. In an example, the control device may be a keypad device, a dimmer switch, or a remote control device. However, the features or characteristics of other control devices may be similarly configured and/or simulated for installation in a space. As shown in FIG. 3A, the user device 129 may display a graphical user interface 202 on a display 125. The graphical user interface 202 may be displayed via a simulation application that may be executed to simulate components of a load control system to a user. The graphical user interface may be the same as, or different than, the graphical user interface 202 shown in FIG. 2A. Additionally, though provided as a single graphical user interface 202, different portions of the graphical user interface 202 may be displayed in different graphical user interfaces or display screens thereon.

The graphical user interface 202 may display icons 204, 206, 208 for selecting different portions, components, or subsystems within the load control system as described herein. Each of the icons 204, 206, 208 may be selected for displaying a different background on the graphical user interface 202 and/or for moving to another screen. For example, the icon 208 may be actuated for selecting portions or components of control devices in the load control system. The control devices may be keypad devices, a dimmer switch, or a remote control device, for example. Though portions or components of other control devices may be similarly selected for configuring the control devices. In response to actuation of the icon 208, for example, the graphical user interface 202 may display one or more functions 310a-310b, as shown in FIG. 3B, related to keypad devices that may be provided via the display 125. For example, the one or more functions 310a-310b may include a function 310b that may be selected for configuring one or more features or characteristics for a keypad device, as described herein. In response to actuation of the function 310b, or an icon displayed therefor, the graphical user interface 202 may display icons 312a, 312b, 312c, as shown in FIG. 3C, that may each represent different styles and/or configurations of keypad devices that each may be configured on a physical keypad device. For example, in response to actuation of the icon 312a, the graphical user interface 202 may display a different style and/or configuration of a keypad device 314a (e.g., via an image or a graphical representation). The keypad device 314a may be comprised of predefined features or characteristics, such as a different predefined size of a faceplate, color of the faceplate, matting of the faceplate, material of the faceplate and/or buttons, number of buttons, and/or functionality. In response to actuation of the icon 312b, the graphical user interface 202 may display a still different style and/or configuration of a keypad device 314b (e.g., via an image or a graphical representation), as shown in FIG. 3D. The keypad device 314b may be comprised of different predefined features and/or characteristics than the keypad device 314a, such as a different predefined size of a faceplate, color of the faceplate, matting of the faceplate, material of the faceplate and/or buttons, number of buttons, and/or functionality. Referring again to FIG. 3C, in response to actuation of the icon 312c, the graphical user interface 202 may display a still different style and/or configuration of a keypad device 314c (e.g., via an image or a graphical representation), as shown in FIG. 3E. The keypad device 314c may have a different predefined features or characteristics than the keypad devices 314a, 314b, such as a different predefined size of a faceplate, color of the faceplate, matting of the faceplate, material of the faceplate and/or buttons, number of buttons, and/or functionality.

As shown in FIGS. 3C-3E, the graphical user interface 202 may display an icon 322 that may be configured to enable customization and/or configuration of a selected keypad device 314a, 314b, 314c. For example, in response to the selection of the icon 322, the graphical user interface 202 may display a keypad configuration tool for customizing and/or configuring the selected keypad device 314a, 314b, 314c. The graphical user interface 202 may also, or alternatively, provide an icon 320, the actuation of which may cause the graphical user interface 202 to revert to displaying an earlier screen.

In response to actuation of the icon 322 of the graphical user interface 202 shown in FIG. 3C, the graphical user interface 202 may provide the keypad configuration tool, as shown in FIGS. 3F and 3G. As illustrated in FIGS. 3F and 3G, the graphical user interface 202 may display a graphical representation of a keypad device 314d for customization and/or configuration. Though other control devices may be similarly customized and/or configured. The graphical representation of the keypad device 314d may be updated with a different style and/or configuration based on selection of other styles and/or configurations by actuation of the icon 316. For example, after actuation of the icon 316, the user may select another keypad device 314a, 314b, 314c and/or options for customization and/or configuration.

The graphical user interface 202 may display icons 318 that may be actuated for updating a button configuration on the graphical representation of the keypad device 314d. For example, icons 318a may be provided to allow the user to select a number of columns of buttons on the graphical representation of a keypad device 314d. The icons 318b may be provided to allow the user to select a number of rows of buttons. However, other icons may be provided to allow the user to select different button configurations. The icons 318 may allow the user to select a number of buttons and/or a button configuration on the graphical representation of the keypad device 314d for simulating configuration and/or use in different systems and/or spaces. As shown in FIGS. 3F and 3G, the size of the graphical representation of the keypad device 314d (e.g., the faceplate thereof) may change (e.g., increase or decrease) based on the number of buttons selected. Additional icons may be displayed to allow the user to change the size of the graphical representation of the keypad device 314d.

One or more buttons displayed on the keypad device 314d may be interactive for receiving user selection. For example, one or more buttons displayed on the keypad device 314d may be configured to receive user input for increasing or decreasing an intensity level, a color temperature level, or otherwise controlling a color or other output of a lighting load. In response to the user selection on the keypad device 314d, the simulation application may simulate a corresponding change of the output of the lighting load on the graphical user interface 202. For example, the graphical user interface 202 may increase or decrease an intensity level and/or a color temperature value (e.g., or otherwise change a color value) provided by the display 125.

The graphical user interface 202 may display icons 330 that may be actuated for updating a color or matting on the graphical representation of the keypad device 314d. The icons 330 may allow the user to select different colors or mattings provided on the graphical representation of the keypad device 314d. The selected color or matting may change a material (e.g., plastic, metal, etc.) represented by the graphical representation of the keypad device 314d. Additional icons may be displayed to allow the user to change the material of the graphical representation of the keypad device 314d. As a user selects icons 330, the graphical representation of the keypad device 314d may be updated to reflect the user selection (e.g., color of faceplate, buttons, and/or other features).

The graphical user interface 202 may display icon 332 that may be actuated for updating a background over which the graphical representation of the keypad device 314d may be overlaid. As shown in FIG. 3H, in response to the actuation of the icon 332 the graphical user interface 202 may display options 333 for being displayed as a background over which the graphical representation of the keypad device 314d may be overlaid. The options 333 may be predefined images that may be separately displayed for being selected by the user. The options 333 may also, or alternatively, include individual colors that may be selected by the user. In response to selection of one of the options 333, the graphical user interface 202 may overlay the graphical representation of the keypad device 314d over the selected background 334, as shown in FIG. 3I. The user may change the background by actuating the icon 332 and selecting another background. Different backgrounds may include different colors to illustrate the effect of different keypads on different colors in the user environment.

Referring again to FIG. 3H, the background 334 may be an image taken by a camera of the user device 129 in response to the selection of an icon 333a. After selection of the icon 333a, the user device 129 may capture and/or generate an image with the camera of the user device 129 over which the graphical representation of the keypad device 314d may be overlaid to allow the features or characteristics of the keypad device 314d to be viewed in the space of the user. The use of the camera on the user device 129 may allow the simulation of the installation of a keypad device having the selected features or characteristics in the physical space of the user. The image captured by the camera of the user device 129 may be a predefined image retrieved from memory on the user device 129. For example, the image that is used as the background 334, as shown in FIG. 3J, may be taken by the camera in response to actuation of an icon (e.g., similar to the icon 221 shown in FIGS. 2M-2R). The image may be stored in memory and/or selected by the user from one or more images. Alternatively, the image may be automatically displayed in response to the actuation of the icon for capturing the image. The image that is used as the background 334 may be one of a series of images (e.g., displayed as a video) on the display 125 of the user device 129. The image being displayed as the background 334 may be one of a series of images recorded live by the camera on the user device 129. As a further example, the image by a live image that changes dynamically as the user moves the user device. While the image or series of images are being displayed with the keypad device 314d being overlaid thereon, the user may update one or more features or characteristics of the graphical representation of the keypad device 314d through the selection of icons 318 and 330 and/or place the location of the graphical representation of the keypad device 314d in a location on the captured image(s) of the space. The images captured by the camera of the user device 129 may be updated in response to changes in location or orientation of the user device 129 and/or changes in settings of load control devices (e.g., lighting control devices) already installed in the load control system to illustrate the effect of changes in the user environment on the features of the keypad device 314d.

FIGS. 3J-3P show further examples of illustrating how the graphical user interface 202 may be implemented to use an image taken by a camera as the background 334. As shown in FIG. 3J, the background 334 may be an image taken by a camera of the user device 129. The graphical user interface 202 may provide options for allowing the user to view images from the camera and/or capture images for being provided as the background 334 in response to the selection of the icon 333a, shown in FIG. 3H. For example, as shown in FIG. 3J, the graphical user interface 202 may display an icon 373 that enables the user to select a predefined image stored in memory. The image may be an image taken by the camera of the user device 129, or another predefined image stored in memory for the background 334. After selection of the icon 373, the graphical user interface 202 may display the options for the background 334, as shown in FIG. 3H, or similarly overlay options for selection of the background 334. When a background image is selected, the image may be displayed as the background 334. When the icon 333a is selected, the graphical user interface 202 may be implemented to use an image taken by a camera as the background 334, as described herein.

Referring again to FIG. 3J, the graphical use interface 202 may also, or alternatively, display an icon 333 that may allow the user to enter an expanded mode for displaying the background in a camera mode of the simulator application to view images generated by the camera on the user device 129 for being captured as the background 334. In response to an actuation of the icon 333, the graphical user interface 202 may provide a view from the camera to allow the user to capture an image for the background 334. As shown in FIGS. 3J-3M, the graphical user interface 202 may perform an animation to transition to the expanded view in the camera mode. The animation may cause a viewing area 317 to be increased and/or other icons for features or characteristics to be removed from the display of the graphical user interface 202 to allow the user to view the images generated by the camera within a larger area of the display 125. As shown in FIG. 3M, after the simulator application is in the camera mode, the user may move the user device 129 to allow the camera to generate different images (e.g., live images) for being provided on the display 125 of the user device 129. The graphical representation of the keypad device 314d may be displayed in a static location on the display 125, such that the user may move the camera of the user device 129 around to place the graphical representation of the keypad device 314d in a particular location on the images being displayed. In another example, the graphical representation of the keypad device 314d may be moved around to different locations (e.g., in response to user input, such as a user selection and drag on the graphical representation of the keypad device 314d) on the display 125 to allow the graphical representation of the keypad device 314d to be placed in a particular location on the images being displayed. After the graphical representation of the keypad device 314d is placed in a desired location, a user may actuate an icon 221a to save a current image of the background and the location of the graphical representation of the keypad device 314d to memory. The background image may be used when the user actuates an icon 337 (e.g., shown in FIGS. 3L and 3M) configured to cause the simulation application to exit the expanded mode for using the image as a background image 334 when updating or selecting features or characteristics of the keypad device, as shown in FIG. 3N. When exiting the expanded mode, the simulation application may perform a similar type of animation (e.g., in a reverse direction) for reducing the viewing area 317 for displaying the background 334 from the image that is stored in memory from the camera of the user device 129. The image may be a static image that is captured for displaying as the background 334 in response to the icon 337 (e.g., similar to the actuation of icon 221a). The simulation application may, again, provide the icons for various settings or characteristics for being displayed on the graphical user interface 202 to allow the user to select features or characteristics of the keypad device for updating the graphical representation. For example, as shown in FIG. 3O, the user may select another color and/or matting for the faceplate and/or button of the keypad device for updating the graphical representation of the keypad device 314d. The user may then select the icon 333 to expand the viewing area 317 in the expanded mode to view the updated graphical representation of the keypad device 314d on other images captured by the camera of the user device 129, as shown in FIG. 3P. As shown in FIG. 3P, when the graphical user interface 202 is displaying the images generated by the camera in the expanded mode, the icon 337 may be displayed to exit the expanded mode for operating the camera and return to providing the icons for various settings or characteristics for being displayed on the graphical user interface 202 to allow the user to select features or characteristics of the keypad device for updating the graphical representation. During the expanded mode, the icon 373 and 221 may also be displayed for allowing selection of previously stored images or take new images.

After the selection of features or characteristics of the keypad device, as shown in FIGS. 3A-3P, the keypad device may be purchased by the user and installed in the load control system. The keypad device, dimmer switch, or remote control device that may be controlled to operate, as described herein, to control one or more electrical loads in the load control system. Similarly, after the features or characteristics of the covering material and/or motorized window treatment are selected, as shown in FIGS. 2A-2R, the covering material and/or the motorized window treatment may be purchased by the user and installed in the load control system. The graphical user interface 202 may provide an option for purchase based on the select features. The motorized window treatment may be controlled to operate in the load control system, as further described herein.

Referring again to FIG. 2A, the graphical user interface 202 may display an icon 204 that may be actuated for selecting portions or components of a lighting control system that may be simulated on the display 125 of the user device 129. In response to the actuation of the icon 204, for example, the graphical user interface 202 may display one or more functions 410a-410c, as shown in FIG. 4A, for displaying information related to a lighting system(s) that may be provided via the display 125. For example, the one or more functions 410a-410c may include a function 410a for providing information related to color control of lighting control devices and/or lighting loads installed in the load control system. In response to actuation of the function 410a, or an icon displayed therefor, the graphical user interface 202 may display information about the control of color in the lighting system. For example, the graphical user interface 202 may display information 412, as shown in FIG. 4B, that describes the features related to color control of lighting loads and/or lighting control devices installed in the load control system. The information 412 may describe that the color control features may include automated color control of the settings of lighting control devices and/or lighting load(s) over time to emulate a sunrise and/or sunset (e.g., which may be referred to as natural show or natural lighting).

The graphical user interface 202 may include an icon 414 configured to provide a color control simulator on the display 125 of the user device 129. The color control simulator may be configured to simulate lighting control settings (e.g., lighting intensity settings, CCT or color temperature settings, full color settings, vibrancy settings affecting color saturation, and/or other lighting control settings) related to color control of lighting control devices and/or lighting loads in the load control system. For example, the color control simulator may be configured to simulate color temperature settings (e.g., lighting intensity settings, CCT or color temperature settings, vibrancy settings affecting color saturation, and/or other color temperature settings) over a time of day for lighting devices installed in the load control system. Though the icon 414 is displayed with the information 412, the icon 414 may be displayed on a screen having another configuration. For example, the color control simulator may be provided directly in response to the actuation of the function 410a or another icon displayed on another screen of the graphical user interface 202. The graphical user interface 202 may be displayed via a simulation application that may be executed to simulate components of a load control system to a user. The graphical user interface may be the same as, or different than, the graphical user interface 202 shown in FIG. 2A. Additionally, though provided as a single graphical user interface 202, different portions of the graphical user interface 202 may be displayed in different graphical user interfaces or display screens thereon.

FIGS. 4C-4G shows an example of the graphical user interface 202 providing the color control simulator on the display 125 of the user device 129. As shown in FIGS. 4C-4G, the color control simulator may provide a color graph 420 that is displayed on the graphical user interface 202. The color graph 420 may be overlaid on an image 430 displayed on the graphical user interface 202.

The color graph 420 may identify different color temperature values on a y-axis. For example, the color graph 420 may display the range of color temperature values or CCT values on the y-axis with warmer colors being identified at one end (e.g., the bottom or bottom portion) of the y-axis and cooler colors being identified at another end (e.g., the top or top portion). The color temperature values may be indicated by a color and/or a value. As another or further example, the color temperature values along the color graph 420 may be indicated by a relative color of the color graph 410 itself at a given location. Warmer colors 422 (e.g., redder or more orange colors) may indicate warmer color temperature values along the color graph 410. Cooler colors 424 (e.g., bluer colors) may indicate cooler color temperature values along the color graph 410. Neutral colors 426 (e.g., white) may indicate color temperature values between the warmer and cooler color temperature values. The color temperature values may be indicated by Kelvin values or other values within a range of color temperature values.

The color graph 420 may identify different times of day on a horizontal x-axis, such that the color graph 420 may be configured with different color temperature values for a corresponding time of day. The ranges on the time of day may be static or may be updated based on user input or location. For example, the user may input a location, or a time for sunrise and/or sunset, via the graphical user interface 202. In another example, the user device 129 may automatically determine the location and/or time of sunrise/sunset. The user may also input a time of year, or the time of year may be automatically determined by the user device 129. The color graph 420 may be updated based on the location and/or times.

The color graph 420 may include a plot that is displayed on a color temperature curve that identifies color temperature values on y-axis at a corresponding time of day on the x-axis. The curve may gradually increase and/or gradually decrease based on the time of day to emulate a change in color temperature values over the course of the day from sunrise to sunset (e.g., which may be referred to as natural show or natural lighting). At a beginning (e.g., beginning portion) and/or an end (e.g., end portion) of the x-axis, the color graph 420 may display warmer temperature values. The color graph 420 may display cooler color temperature values between the beginning and end (e.g., at a middle portion) of the color graph 420 on the x-axis. The change in color temperature values along the color temperature curve may represent a rise and fall of color temperature values over the time of day. The color temperature values and/or the corresponding times of day may correspond to the settings of the lighting control system when performing automated color control, as described herein. The curve may be displayed differently for different locations and/or times of year.

As shown in FIGS. 4C-4G, the image 430 may be updated in response to a different time of day and/or a different color temperature value being selected on the color graph 420. For example, a user may select a location on the color graph 420, and/or otherwise select a time of day and/or color temperature value (via a separate actuator on the graphical user interface 202), and the image 430 may be updated to simulate the color temperature that may be output by the lighting loads in the load control system for the selected time of day and/or color temperature value. The selected time of day 429 may be indicated on the graphical user interface 202. The selected color temperature value 428 may be indicated by a cursor on the graphical user interface. The selected time of day 429 and/or color temperature value 428 may be indicated separately or together. For example, the selected color temperature value 428 and/or time of day 429 may be indicated by a cursor or another indicator on a plot of the color graph 420. The selected time of day 429 and/or the color temperature value 428 may be separately displayed (e.g., via text) on the graphical user interface 202. The cursor may move along the plot of the color graph 420 to identify different values for the time of day 429 and/or color temperature value 428.

The image 430 may be updated at or within predefined times of day and/or color temperature values/ranges to reflect a color temperature at which lighting control devices and/or lighting loads may be controlled in the lighting system. An updated image 430 may be displayed to simulate the selected color temperature value 428 at the corresponding time of day 429. As shown in FIGS. 4C-4G, image 430 over which the color graph 420 is overlaid may be updated in response to different predefined times of day and/or color temperature values/ranges. The images 430 may include predefined images that are tagged and stored in memory with a time or range of times of day, and/or a color temperature value or range of color temperature values. The images 430 may be tagged and stored in memory with a predefined time of year and/or location. The images may be captured by a camera over a period of a day over which the automated lighting control system may be operating to change the color settings of the lighting control devices for controlling the lighting loads. The images captured by the camera of the user device 129 may be updated to reflect the color temperature values/ranges at which lighting control devices and/or lighting loads may be controlled in the lighting system. The images captured by the camera of the user device 129 may be updated in response to changes in location or orientation of the user device 129 and/or changes in settings of load control devices (e.g., lighting control devices, a level of a covering material of a motorized window treatment, etc.) already installed in the load control system to illustrate the effect of changes in combination with the automated lighting control system. Predefined images may be selected for representing given color temperature values at selected times of day and/or color temperature values/ranges and stored in memory for being displayed on the graphical user interface 202. Additionally, or alternatively, one or more images (e.g., camera images) may be modified to achieve an image that represents the selected color temperature value or range of color temperature values. For example, an image may be taken of a space via the camera of the user device 129 and modified with one or more color filters or other image processing software to generate and store an image that represents or reflects the selected color temperature value. A respective image 430 may be displayed in response to a selected time of day 429 and/or color temperature value 428.

In another example as shown by the series of FIGS. 4A-4G, the images 430 may be displayed (e.g., automatically or in response to a user input) in series over a timeline as the selected time of day 429 and/or the color temperature value 428 are updated on the plot on the color graph 420 over a timeline. This may be referred to as a “play mode”. During the play mode, the indicator of the color temperature value 428 may automatically move along the plot of the curve and a time of day is updated on the display 425 as the indicator of the color temperature value 428 moves. During the play mode, the time is updated faster than real time, and over a predefined period. Each respective image 430 that is displayed may also, or alternatively, be tagged and stored with a corresponding lighting intensity level or range of lighting intensity levels. Each respective image 430 that is displayed may reflect a corresponding lighting intensity level at which the lighting control devices and/or the lighting loads in the system may be controlled at the selected time of day 429 and/or color temperature value 428. During the play mode, the color temperature value reflected in the images 430 tracks a predefined range of values on the curve. The play mode may be stopped or paused in response to a user input (e.g., user selection of the indicator of the color temperature value 428 or other actuation on the display 202). After the play mode is stopped or paused, the user may drag the indicator of the color temperature value 428 along the curve to display other images representing color temperature values. The color control simulator may be exited in response to actuation of the icon 440 and/or the graphical user interface 202 may revert to displaying an earlier screen.

After the user views the color control features or characteristics of the automated lighting control system, as shown in FIGS. 4A-4G, the automated lighting control system, or components thereof, may be purchased by the user and installed in the load control system. The graphical user interface 202 may provide an option for purchase the system and/or components therein. The automated lighting control system may then be controlled to operate, as described herein.

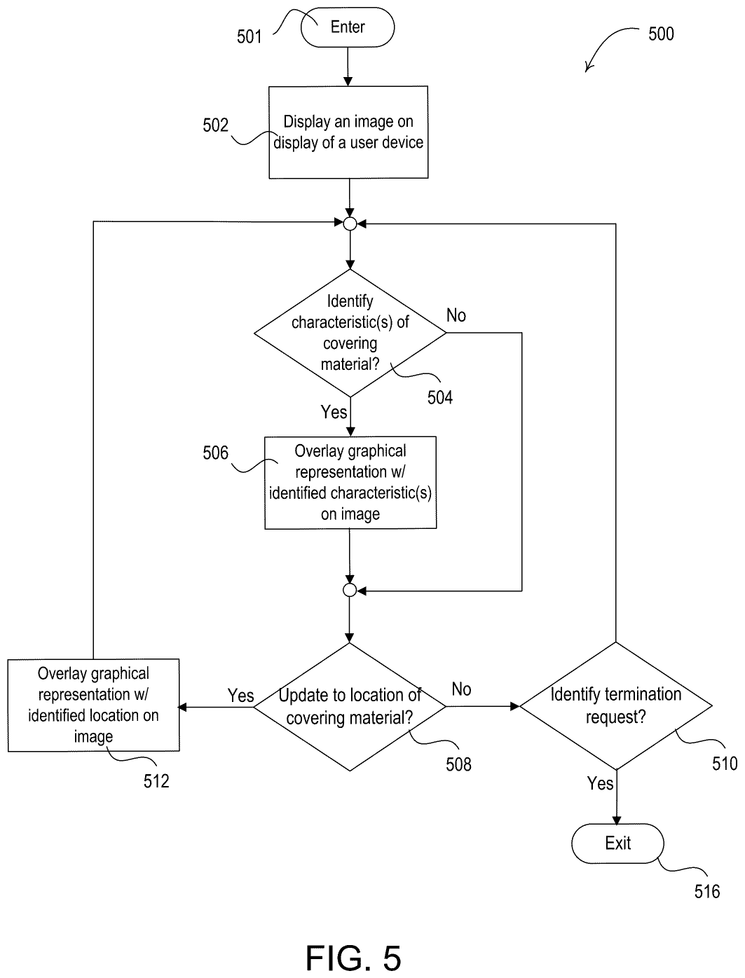

FIG. 5 is a flow diagram of an example procedure 500 for simulating one or more features of a motorized window treatment and/or a covering material of the motorized window treatment. The procedure 500 may be performed by one or more portions of a simulation application executing on one or more devices to simulate components of a load control system to a user. As described herein, the one or more portions of the simulation application may be executed by the control circuit of a computing device for performing one or more portions of the procedure 500. For example, one or more control circuits may execute one or more computer-executable instructions or machine-readable instructions stored in memory to perform one or more portions of the procedure 500. One or more portions of the procedure 500 may be operated locally on a computing device, such as a user device, and/or remotely on another computing device.

The procedure 500 may begin at 501 in response to an indication from a user to simulate one or more features of a motorized window treatment and/or a covering material (e.g., window treatment fabric) of the motorized window treatment. At 502, the simulation application may display an image on a display of a user device. The image may be a predefined image or an image recorded by a camera on the user device. The image may be a single predefined image or one of a sequence of images recorded live by the camera on the user device.

At 504, the simulation application may determine whether one or more characteristics of a covering material have been identified. For example, the one or more characteristics of the covering material may be identified in response to a user indication, or one or more default characteristics may be predefined for initial display. The one or more characteristics of the covering material may include an openness factor of the covering material and/or a color of the covering material. If, at 504, the simulation application determines that one or more characteristics of a covering material have been identified, the simulation application may overlay a graphical representation of the covering material on the image being displayed on the user device at 506. For example, the graphical representation may include the identified openness factor of the covering material and/or the identified color. The graphical representation of the covering material may allow for a portion of the image to be displayed through the covering material to simulate the openness factor and/or color of the covering material installed in the space. As the openness factor may be identified as a percentage or other ratio of the open space of the covering material, different percentages or ratios of open space may be identified to allow for different portions of the image to be visible to the user.

If one or more characteristics of the covering material are not identified at 504, or after the characteristics of the covering material have been updated at 506, the simulation application may determine whether to update to the location of the covering material at 508 and/or whether a termination request has been identified at 510. The location of the covering material over the image may simulate a level of the covering material being controlled by the window treatment. For example, the simulation application may identify input from the user to change a location of the graphical representation on the covering material at 508, or identify a default location that is predefined in memory, and determine at 512 to overlay the graphical representation in a certain location on the image. The change in the location of the graphical representation may be identified by actuation of one or more buttons (e.g., up, down, left, right buttons) and/or a user actuation of a portion of the covering material or hembar to drag the covering material to an identified level or location on the image. The simulation application may adjust the location of a bottom hembar (e.g., for a top-down window treatment), a top hembar (e.g., for a bottom-up window treatment), or a side of the window treatment fabric (e.g., for a drapery) on the display of the user device to simulate an adjustment in a position of the covering material as the covering material would be moved by a motorized window treatment in the space.

The characteristics and/or the location of the covering material may continue to be updated based on the user input. For example, the procedure 500 may revert back to 504 to identify additional updates to one or more characteristics for updating the overlay of the graphical representation (e.g., based on a change in openness factor and/or color) at 506. The simulation application may identify additional changes to the level of the covering material at 508 and continue to update the graphical representation with the changes in the level on the image being displayed.

At any time the simulation application may identify a termination request at 510 in response to a user indication to exit the simulation application or a screen of the simulation application. If the termination request is identified at 510, the procedure 500 may end at 516. For example, when the termination request is identified at 510, the simulation application may be terminated and/or revert to displaying an earlier screen in the application.

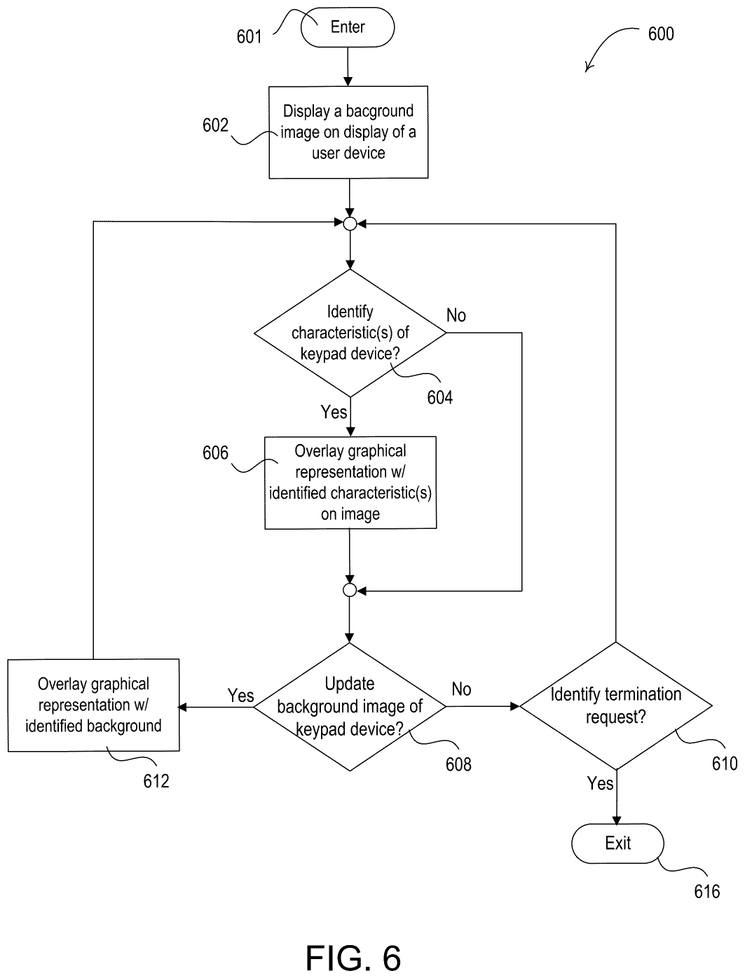

FIG. 6 is a flow diagram of an example procedure 600 for simulating one or more features of a control device keypad device (e.g., keypad device, a dimmer switch, or a remote control device). The procedure 600 may be performed by one or more portions of a simulation application executing on one or more devices to simulate components of a load control system to a user. As described herein, the one or more portions of the simulation application may be executed by the control circuit of a computing device for performing one or more portions of the procedure 600. For example, one or more control circuits may execute one or more computer-executable instructions or machine-readable instructions stored in memory to perform one or more portions of the procedure 600. One or more portions of the procedure 600 may be operated locally on a computing device, such as a user device, and/or remotely on another computing device.

The procedure 600 may begin at 601 in response to an indication from a user to simulate one or more features of a keypad device, for example. At 602, the simulation application may display an image on a display of a user device. The image may be a predefined image or an image recorded by a camera on the user device. The image may be a single predefined image or one of a sequence of images recorded live by the camera on the user device. The image may be a background image over which a graphical representation of a keypad device may be displayed.

At 604, the simulation application may determine whether one or more characteristics of a keypad device have been identified. For example, the one or more characteristics of the keypad device may be identified in response to a user indication, or one or more default characteristics may be predefined for initial display. The one or more characteristics of the keypad device may include a color of a faceplate, a size of a faceplate, and/or a button configuration of the keypad device. If, at 604, the simulation application determines that one or more one or more characteristics of a keypad device have been identified, the simulation application may overlay a graphical representation of the keypad device on the image being displayed on the user device at 606. For example, the graphical representation may include the one or more features of the keypad device that have been identified. The graphical representation of the keypad device may allow for the keypad device to be displayed over a background image to simulate the installation of the keypad device in a space.

If one or more characteristics of the keypad device are not identified at 604, or after the one or more characteristics of the keypad device are updated at 606, the simulation application may determine whether to update the background image of the keypad device at 608 and/or whether a termination request has been identified at 610. The updated background image may simulate a background or space in which the keypad device may be installed. For example, the simulation application may identify an indication to display an image, or sequence of images, from a camera of the user device at 608, or identify a default image that is predefined in memory, and determine at 612 to overlay the graphical representation of the keypad device on the background image. The graphical representation of the keypad device may be displayed at a predefined location on the background image, or may be positioned in a location in response to a user indication on the user device.

The characteristics and/or the background of the keypad device may continue to be updated based on the user input. For example, the procedure 600 may revert back to 604 to identify additional updates to one or more characteristics for updating the overlay of the graphical representation (e.g., based on a change in a color of a faceplate, a size of a faceplate, and/or a button configuration of the keypad device) at 606. The simulation application may identify additional changes to the background image at 608 and continue to update the graphical representation with the changes in the background image being displayed at 612.

At any time the simulation application may identify a termination request at 610 in response to a user indication to exit the simulation application or a screen of the simulation application. If the termination request is identified at 610, the procedure 600 may end at 616. For example, when the termination request is identified at 610, the simulation application may be terminated and/or revert to displaying an earlier screen in the application.

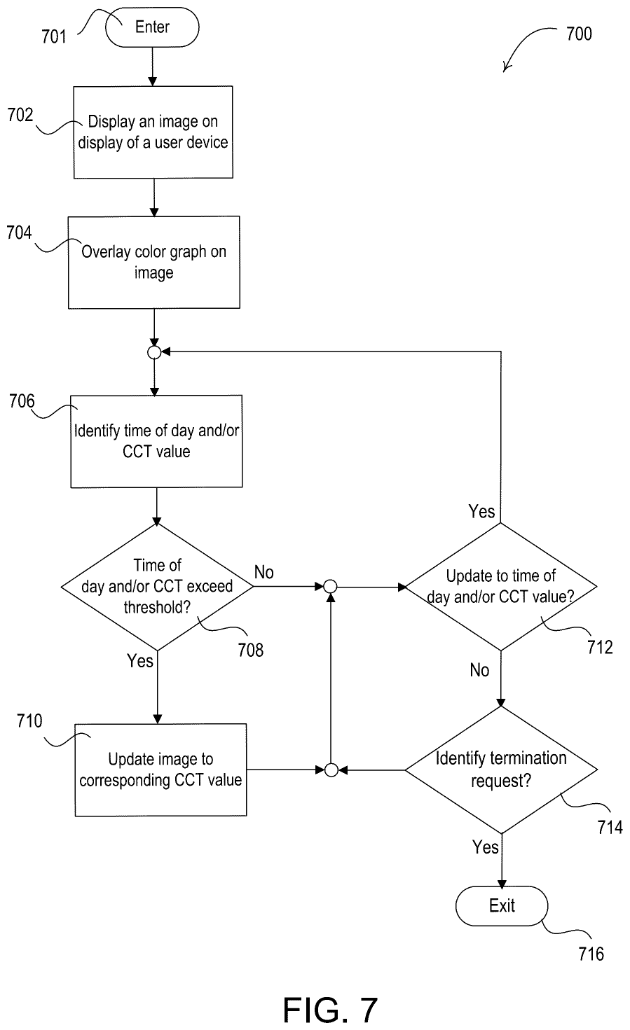

FIG. 7 is a flow diagram of an example procedure 700 for simulating one or more features of a lighting control system (e.g., an automated lighting control system) configured to control various color settings, such as CCT settings, full color settings, and/or vibrancy settings affecting color saturation, over time (e.g., via natural show or natural lighting settings) to emulate a sunrise and/or sunset. The procedure 700 may be performed by one or more portions of a simulation application executing on one or more devices to simulate components of a load control system to a user. As described herein, the one or more portions of the simulation application may be executed by the control circuit of a computing device for performing one or more portions of the procedure 700. For example, one or more control circuits may execute one or more computer-executable instructions or machine-readable instructions stored in memory to perform one or more portions of the procedure 700. One or more portions of the procedure 700 may be operated locally on a computing device, such as a user device, and/or remotely on another computing device.

The procedure 700 may begin at 701 in response to an indication from a user to simulate one or more features of a lighting control system configured to control various color settings over time (e.g., via natural show or natural lighting settings) to emulate a sunrise and/or sunset. At 702, the simulation application may display an image on a display of a user device. The image may be a predefined image. The image may be one of a number of tagged and stored images in memory with a predefined time of year and/or location. The image may be a default image to be displayed initially for the simulation of the features of the lighting control system. The image may be one of a series of images captured by a camera over a period of a day over which the automated lighting control system may be operating to change the color settings of the lighting control devices for controlling the lighting loads. Additionally, or alternatively, the image may be one of one or more modified images that have been modified to achieve a representation of selected color temperature values or a range of color temperature values. For example, the image may have been taken of a space and modified with one or more color filters or other image processing software to generate and store the image to represent or reflect a color temperature value.

At 704, a color graph may be overlaid on the image being displayed. The color graph may identify different color temperature values on a y-axis and different times of day on an x-axis. The color graph may be configured with different color temperature values for controlling lighting loads at a corresponding time of day. The color graph may include a plot of values that is displayed on a color temperature curve that identifies color temperature values on y-axis at a corresponding time of day on the x-axis. The plot may gradually increase and/or gradually decrease (e.g., at a defined speed and/or defined gradient) based on the time of day to emulate a change in color temperature values over the course of the day from sunrise to sunset (e.g., which may be referred to as natural show or natural lighting). At a beginning (e.g., beginning portion) and/or an end (e.g., end portion) of the x-axis, the color graph may display warmer temperature values. The color graph may display cooler color temperature values between the beginning and end (e.g., at a middle portion) of the color graph on the x-axis. The change in color temperature values along the color temperature curve may represent a rise and fall of color temperature values over the time of day. The color temperature values and/or the corresponding times of day may correspond to the settings of the lighting control system when performing automated color control, as described herein. The plot may be displayed differently for different locations and/or times of year.

At 706, a time of day and/or color temperature value may be identified. For example, the selected time of day and/or color temperature value may be indicated by a user on a graphical user interface. The time of day and/or the color temperature value may be indicated by a cursor or another indicator on the plot of the color graph. At 708, the simulation application may determine whether a time of day and/or a CCT value exceed a threshold change in the time of day and/or CCT value for the current image being displayed on the user interface. For example, the user may select a time of day that is later in time or earlier in time, or a color temperature value that his higher or lower in value, than the time/color temperature stored in memory for the current image being displayed. This may allow the user to move forward or backward in time of day, or select different color temperature values, for simulating the control of the lighting control system. In another example, the time of day and/or color temperature value may change over a period of time in a mode that may be referred to as a “play mode,” during which the time of day and/or color temperature value may be changes continuously over the period of time.

When the time and/or color temperature value exceeds a threshold amount of change at 708, the time and/or color temperature value may correspond to a different image of a series of images stored in memory (e.g., images captured by a camera over a period of a day and/or modified images that represent a selected color temperature value or a range of color temperature values). When the identified time and/or color temperature value exceeds the threshold amount of change at 708, the simulation application may update the image at 710 to reflect a different color temperature value. The updated image may reflect the corresponding color temperature value at which the lighting devices would be controlled in the lighting system to simulate the color temperature value at the identified time of day in the space based on where the cursor is on the curve. The updated image may include windows to simulate the color temperature value coming into the space from outside the windows at the identified time of day in the space based on where the cursor is on the curve. The simulation application may continue to monitor for updates to a time of day and/or a color temperature value at 712. If an updated time of day and/or color temperature value are detected, at 712, the procedure 700 may revert back to 706 and the simulation application may identify the update time of day and/or CCT value to determine whether to update the image based on the change.

At any time the simulation application may identify a termination request at 714 in response to a user indication to exit the simulation application or a screen of the simulation application. In another example, at the end of the play mode, the termination request may be automatically identified, at 714. If the termination request is identified at 714, the procedure 700 may end at 716. For example, when the termination request is identified at 714, the simulation application may be terminated and/or revert to displaying an earlier screen in the application.

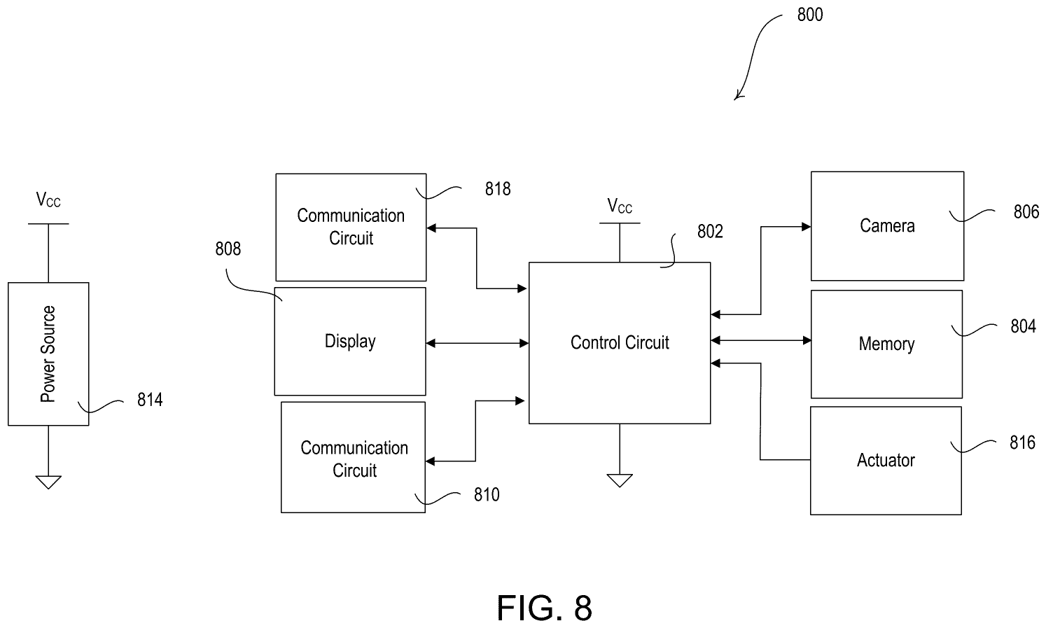

FIG. 8 is a block diagram illustrating an example computing device 800. For example, the computing device 800 may be a user device (such as the user device 129, described herein), a system controller (such as the system controller 110, described herein), a remote computing device operating remote services (such as the remote computing system operating remote services 164, described herein), an input device (such as wired keypad device 150, wired sensor 167, remote control device 152, occupancy sensor 154, and/or daylight sensor 156), and/or another computing device as described herein. The computing device 800 may include a control circuit 802 for controlling the functionality of the computing device 800. The control circuit 802 may include one or more general purpose processors, special purpose processors, conventional processors, digital signal processors (DSPs), microprocessors, integrated circuits, a programmable logic device (PLD), application specific integrated circuits (ASICs), and/or the like. The control circuit 802 may perform signal coding, data processing, power control, image processing, input/output processing, and/or any other functionality that enables the computing device 800 to perform as described herein.

The control circuit 802 may store information in and/or retrieve information from the memory 804. The memory 804 may include a non-removable memory and/or a removable memory. The non-removable memory may include random-access memory (RAM), read-only memory (ROM), a hard disk, and/or any other type of non-removable memory storage. The removable memory may include a subscriber identity module (SIM) card, a memory stick, a memory card (e.g., a digital camera memory card), and/or any other type of removable memory. The memory 804 may be a non-transitory computer-readable medium having computer-executable instructions stored thereon that, when executed by the control circuit 802, cause the control circuit to operate a respective device, as described herein. For example, the memory 804 may have computer-executable instructions stored thereon that, when executed by the control circuit 802, cause the control circuit to execute one or more portions of software and/or operate in response to input, as described herein.

The computing device 800 may include a camera 806 that may be in communication with the control circuit 802. The camera 806 may include a digital camera or other optical device configured to generating images or videos (e.g., image sequences) for being captured at the computing device 800 using visible light. The camera 806 may include a light configured to flashing, modulating, or turning on/off in response to signals received from the control circuit.

The computing device 800 may include a first communication circuit 810 for transmitting and/or receiving information. The first communication circuit 810 may perform wired or wireless communications. For example, the first communication circuit 810 may perform wired or wireless communications on a first communication link and/or network (e.g., a network wireless communication link). The computing device 800 may also, or alternatively, include a second communication circuit 818 for transmitting and/or receiving information. The second communication circuit 818 may perform communications via a second communication link and/or network (e.g., a short-range wireless communication link). The first and second communication circuit 810, 818 may be in communication with control circuit 802. The first and second communication circuits 810 and 818 may include RF transceivers or other communications modules configured to performing wireless communications via an antenna. The first communication circuit 810 and second communication circuit 818 may be configured to performing communications via the same communication channels or different communication channels. For example, the first communication circuit 810 may be configured to communicate (e.g., with control devices and/or other devices in the load control system) via the first communication link and/or network using a first wireless communication protocol (e.g., a network wireless communication protocol, such as the CLEAR CONNECT and/or THREAD protocols) and the second communication circuit 818 may be configured to communicate via the second communication channel and/or network using a second wireless communication protocol (e.g., a short-range wireless communication protocol, such as the BLUETOOTH and/or BLUETOOTH LOW ENERGY (BLE) protocols, WiFi protocols, cellular protocols, etc.).

The control circuit 802 may also be in communication with a display 808. The display 808 may provide information to a user in the form of a graphical and/or textual display. The communication between the display 808 and the control circuit 802 may be a two-way communication, as the display 808 may include a touch screen module configured to receiving information from a user and providing such information to the control circuit 802.

The computing device 800 may include an actuator 816. The control circuit 802 may be responsive to the actuator 816 for receiving a user input. For example, the control circuit 802 may be operable to receive a button press from a user on the computing device 800 for making a selection, transmitting command messages, or performing other functionality on the computing device 800.

One or more of the circuits within the computing device 800 may be powered by a power source 814. The power source 814 may include an AC power supply or DC power supply, for example. The power source 814 may generate a DC supply voltage V_{CC} for powering the circuits within the computing device 800.

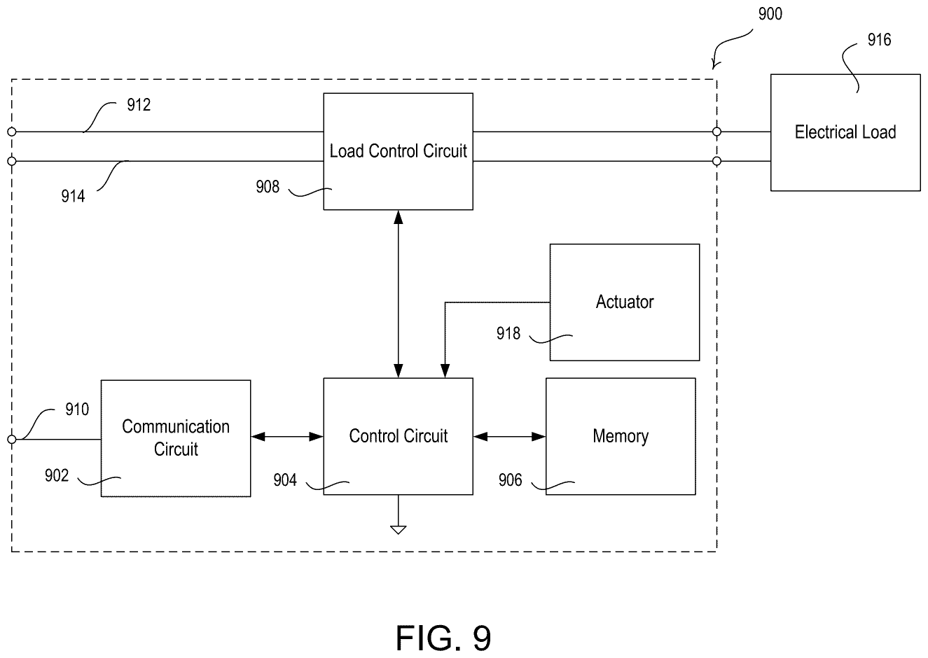

FIG. 9 is a block diagram illustrating an example load control device 900, as described herein. The load control device 900 may be a dimmer switch, an electronic switch, an electronic ballast for lamps, an LED driver for LED light sources, an AC plug-in load control device, a temperature control device (e.g., a thermostat), a motor drive unit for a motorized window treatment, or other load control device. The load control device 900 may include a communication circuit 902. The communication circuit 902 may include a receiver, an RF transceiver, or other communications module configured to performing wired and/or wireless communications via communications link 910. The communication circuit 902 may be in communication with control circuit 904. The control circuit 904 may include one or more general purpose processors, special purpose processors, conventional processors, digital signal processors (DSPs), microprocessors, integrated circuits, a programmable logic device (PLD), application specific integrated circuits (ASICs), or the like. The control circuit 904 may perform signal coding, data processing, power control, input/output processing, or any other functionality that enables the load control device 900 to perform as described herein.

The control circuit 904 may store information in and/or retrieve information from the memory 906. For example, the memory 906 may maintain a registry of associated control devices and/or control instructions. The memory 906 may include a non-removable memory and/or a removable memory. The load control circuit 908 may receive instructions from the control circuit 904 and may control the electrical load 916 based on the received instructions. The load control circuit 908 may send status feedback to the control circuit 904 regarding the status of the electrical load 916. The load control circuit 908 may receive power via the hot connection 912 and the neutral connection 914 and may provide an amount of power to the electrical load 916. The electrical load 916 may include any type of electrical load.

The control circuit 904 may be in communication with an actuator 918 (e.g., one or more buttons) that may be actuated by a user to communicate user selections to the control circuit 904. For example, the actuator 918 may be actuated to put the control circuit 904 in an association mode and/or communicate association messages from the load control device 900.

Although features and elements have been described in relation to particular embodiments, many other variations, modifications, and other uses are apparent from the description provided herein. For example, while various types of hardware and/or software may be described for performing various features, other hardware and/or software modules may be implemented. The disclosure herein may not be limited by the examples provided.

What is claimed is:

1. A method for simulating at least one characteristic of a window treatment fabric in a space, the method comprising:
displaying an image on a display of a user device;
identifying the at least one characteristic of the window treatment fabric, wherein the at least one characteristic comprises an openness factor of the window treatment fabric;
overlaying a graphical representation of the window treatment fabric on the image being displayed on the display of the user device, the graphical representation of the window treatment fabric having the identified openness factor over the image being displayed, wherein the graphical representation of the window treatment fabric allows for a portion of the image to be displayed through the window treatment fabric to simulate the openness factor of the window treatment fabric being installed in a space.

2. The method of claim 1, wherein the openness factor is one of a plurality of openness factors, and wherein the openness factor is identified in response to a user selection of the openness factor from the plurality of openness factors.

3. The method of claim 2, wherein the openness factor is a first openness factor, wherein the graphical representation is a first graphical representation, the method comprising:
receiving an indication of a user selection of a second openness factor; and
overlaying a second graphical representation of the window treatment fabric having the second openness factor over the image being displayed, wherein the second graphical representation of the window treatment fabric allows for a second portion of the image to be displayed through the window treatment fabric to simulate the second openness factor of the window treatment fabric.

4. The method of claim 3, wherein the first openness factor and the second openness factor are defined with different percentages of openness.

5. The method of claim 4, wherein the second openness factor is less than 1%.

6. The method of claim 1, further comprising:
generating the image via a camera on the user device.

7. The method of claim 6, wherein the image is one of a plurality of images recorded live by the camera on the user device.

8. The method of claim 1, further comprising:
retrieving the image as a predefined image from memory on the user device.

9. The method of claim 1, wherein the at least one characteristic comprises a color of a plurality of colors of the window treatment fabric, wherein the window treatment fabric is overlaid on the display in a first color, the method further comprising:
receiving an indication of a user selection of a second color of the window treatment fabric; and
overlaying a graphical representation of the window treatment fabric on the image in the second color.

10. The method of claim 1, wherein the openness factor comprises a first openness factor, wherein the at least one characteristic further comprises a color of a plurality of colors of the window treatment fabric, wherein the window treatment fabric is overlaid on the display in a first color, the method further comprising:
receiving an indication of a user selection to change the openness factor to a second openness factor;
overlaying a graphical representation of the window treatment fabric on the image in the first color in the second openness factor;
receiving an indication of a user selection to change the color of the window treatment fabric from the first color to a second color; and
overlaying a graphical representation of the window treatment fabric on the image in the second color and in the second openness factor.

11. The method of claim 1, further comprising:
adjusting a location of a bottom hembar of the window treatment fabric on the display of the user device to simulate an adjustment in a position of the window treatment fabric as the window treatment fabric would be moved up or down by a motorized window treatment in the space.

12. The method of claim 1, wherein the openness factor indicates at least an area of open space in the window treatment fabric.

13. An apparatus comprising:
a display; and
a control circuit configured to:
display an image on the display;
identify at least one characteristic of a window treatment fabric, wherein the at least one characteristic comprises an openness factor of the window treatment fabric; and
overlay a graphical representation of the window treatment fabric on the image being displayed on the display, the graphical representation of the window treatment fabric having the identified openness factor over the image being displayed, wherein the graphical representation of the window treatment fabric allows for a portion of the image to be displayed through the window treatment fabric to simulate the openness factor of the window treatment fabric being installed in a space.

14. The apparatus of claim 13, wherein the openness factor is one of a plurality of openness factors, and wherein the openness factor is configured to be identified by the control circuit in response to a user selection of the openness factor from the plurality of openness factors.

15. The apparatus of claim 14, wherein the openness factor is a first openness factor, wherein the graphical representation is a first graphical representation, and wherein the control circuit is further configured to:
receive an indication of a user selection of a second openness factor; and
overlay a second graphical representation of the window treatment fabric having the second openness factor over the image being displayed, wherein the second graphical representation of the window treatment fabric allows for a second portion of the image to be displayed through the window treatment fabric to simulate the second openness factor of the window treatment fabric.

16. The apparatus of claim 15, wherein the first openness factor and the second openness factor are defined with different percentages of openness.

17. The apparatus of claim 16, wherein the second openness factor is less than 1%.

18. The apparatus of claim 13, further comprising a camera configured to generate the image.

19. The apparatus of claim 18, wherein the image is one of a plurality of images recorded live by the camera.

20. The apparatus of claim 13, further comprising a memory, and wherein the control circuit is further configured to retrieve the image as a predefined image from the memory.

21. The apparatus of claim 13, wherein the at least one characteristic comprises a color of a plurality of colors of the window treatment fabric, wherein the control circuit is configured to overlay the window treatment fabric on the display in a first color, the control circuit being further configured to:
receive an indication of a user selection of a second color of the window treatment fabric; and
overlay a graphical representation of the window treatment fabric on the image in the second color.

22. The apparatus of claim 13, wherein the openness factor comprises a first openness factor, wherein the at least one characteristic further comprises a color of a plurality of colors of the window treatment fabric, wherein the control circuit is configured to overlay the window treatment fabric on the display in a first color, the control circuit being further configured to:
receive an indication of a user selection to change the openness factor to a second openness factor;
overlay a graphical representation of the window treatment fabric on the image in the first color in the second openness factor;
receive an indication of a user selection to change the color of the window treatment fabric from the first color to a second color; and
overlay a graphical representation of the window treatment fabric on the image in the second color and in the second openness factor.

23. The apparatus of claim 13, wherein the control circuit is further configured to:
adjust a location of a bottom hembar of the window treatment fabric on the display of the user device to simulate an adjustment in a position of the window treatment fabric as the window treatment fabric would be moved up or down by a motorized window treatment in the space.

24. The apparatus of claim 13, wherein the openness factor indicates at least an area of open space in the window treatment fabric.

25. At least one computer-readable storage medium having instructions stored thereon that are configured to, when executed by at least one control circuit, cause the at least one control circuit to:
display an image;
identify at least one characteristic of a window treatment fabric, wherein the at least one characteristic comprises an openness factor of the window treatment fabric; and
overlay a graphical representation of the window treatment fabric on the image being displayed on the display, the graphical representation of the window treatment fabric having the identified openness factor over the image being displayed, wherein the graphical representation of the window treatment fabric allows for a portion of the image to be displayed through the window treatment fabric to simulate the openness factor of the window treatment fabric being installed in a space.

26. The at least one computer-readable storage medium of claim 25, wherein the openness factor is one of a plurality of openness factors, and wherein the instructions are configured to cause the control circuit to identify the openness factor in response to a user selection of the openness factor from the plurality of openness factors.

27. The at least one computer-readable storage medium of claim 26, wherein the openness factor is a first openness factor, wherein the graphical representation is a first graphical representation, and wherein the instructions are further configured to cause the control circuit to:
receive an indication of a user selection of a second openness factor; and
overlay a second graphical representation of the window treatment fabric having the second openness factor over the image being displayed, wherein the second graphical representation of the window treatment fabric allows for a second portion of the image to be displayed through the window treatment fabric to simulate the second openness factor of the window treatment fabric.

28. The at least one computer-readable storage medium of claim 27, wherein the first openness factor and the second openness factor are defined with different percentages of openness.

29. The at least one computer-readable storage medium of claim 28, wherein the second openness factor is less than 1%.

30. The at least one computer-readable storage medium of claim 25, wherein the instructions are further configured to cause the control circuit to generate the image via a camera.

31. The at least one computer-readable storage medium of claim 30, wherein the image is one of a plurality of images recorded live by the camera.

32. The at least one computer-readable storage medium of claim 25, wherein the instructions are configured to cause the control circuit to retrieve the image as a predefined image from memory.

33. The at least one computer-readable storage medium of claim 25, wherein the at least one characteristic comprises a color of a plurality of colors of the window treatment fabric, wherein the instructions are further configured to cause the control circuit to overlay the window treatment fabric on the display in a first color, the instructions being further configured to cause the control circuit to:
receive an indication of a user selection of a second color of the window treatment fabric; and
overlay a graphical representation of the window treatment fabric on the image in the second color.

34. The at least one computer-readable storage medium of claim 25, wherein the openness factor comprises a first openness factor, wherein the at least one characteristic further comprises a color of a plurality of colors of the window treatment fabric, wherein the instructions are further configured to cause the control circuit to overlay the window treatment fabric on the display in a first color, wherein the instructions are further configured to cause the control circuit to:
receive an indication of a user selection to change the openness factor to a second openness factor;
overlay a graphical representation of the window treatment fabric on the image in the first color in the second openness factor;
receive an indication of a user selection to change the color of the window treatment fabric from the first color to a second color; and
overlay a graphical representation of the window treatment fabric on the image in the second color and in the second openness factor.

35. The at least one computer-readable storage medium of claim 25, wherein the instructions are further configured to cause the control circuit to:
adjust a location of a bottom hembar of the window treatment fabric on the display of the user device to simulate an adjustment in a position of the window treatment fabric as the window treatment fabric would be moved up or down by a motorized window treatment in the space.

36. The at least one computer-readable storage medium of claim 25, wherein the openness factor indicates at least an area of open space in the window treatment fabric.

37-84. (canceled)
